(19) United States
(12) Patent Application Publication
(10) Pub. No.: US 2013/0282423 A1
(43) Pub. Date: Oct. 24, 2013

(54) CROP CULTIVATION SUPPORT METHOD AND APPARATUS

(71) Applicant: Fujitsu Limited, Kawasaki-shi (JP)

(72) Inventors: Mitsuyoshi HORI, Kawasaki (JP); Koji WATANABE, Hachioji (JP); Yuki OHARA, Sapporo (JP)

(21) Appl. No.: 13/925,014

(22) Filed: Jun. 24, 2013

Related U.S. Application Data
(63) Continuation of application No. PCT/JP2011/062290, filed on May 27, 2011.

(30) Foreign Application Priority Data
Dec. 24, 2010 (JP) 2010-287939

(51) Int. Cl. G06Q 50/02

(52) U.S. Cl. CPC G06Q 50/02; G06Q 10/06315
USPC 705/7.25

(57) ABSTRACT

A crop cultivation support method that is executed by a computer includes retrieving from among dispersed fields displayed on a map on a screen, a set of fields as cultivation candidates for a designated crop, based on properties of the fields; determining from among the set of fields and based on estimated yields of the designated crop for each of the fields in the set of fields, a field combination that satisfies a targeted yield of the designated crop; changing a display format of each of the fields in the field combination to a predetermined display format that differs from a display format of other fields excluded from the field combination, and displaying the fields in field combination in the predetermined display format on the map.

### CROSS REFERENCE TO RELATED APPLICATIONS

This is a continuation application of International Application PCT/JP2011/062290 filed on May 27, 2011 which claims priority from a Japanese Patent Application No. 2010-287939 filed on Dec. 24, 2010, the contents of which are incorporated herein by reference.

### FIELD

The embodiment discussed herein is related to a crop cultivation support method and a crop cultivation support apparatus that support the cultivation of crops.

### BACKGROUND

Conventionally, various technologies that support the cultivation of crops have been disclosed. For example, an agricultural field is divided into sections, the gross margin of each section is calculated from past yields, and one or more sections yielding the greatest gross margin is selected from among the plots (see, for example, Japanese Laid-Open Patent Publication No. 2002-189772).

According to another technology, the components of gardening soil, potting soil, soil for planters, etc. is analyzed, crops suitable for cultivation are selected, and fertilizers necessary for the designated crops are determined (see, for example, Japanese Laid-Open Patent Publication No. 2000-83476). According to another technology, crops suitable for given agricultural land are presented based on market value information and cultivation information for the crops, annual climate information for the region in which the land is located, etc. (see, for example, Japanese Laid-Open Patent Publication No. 2005-80514).

Nonetheless, with the technologies above, a problem arises in that determining which crop to cultivate in which field is difficult with respect to crop planning for a large number of fields that are dispersed. For example, if a shipping date for a several ton harvest has been set, determining which fields should be used to guarantee the targeted yield is difficult and the workload related to crop planning is enormous.

### SUMMARY

According to an aspect of an embodiment, a crop cultivation support method that is executed by a computer includes retrieving from among dispersed fields displayed on a map on a screen, a set of fields as cultivation candidates for a designated crop, based on properties of the fields; determining from among the set of fields and based on estimated yields of the designated crop for each of the fields in the set of fields, a field combination that satisfies a targeted yield of the designated crop; changing a display format of each of the fields in the field combination to a predetermined display format that differs from a display format of other fields excluded from the field combination, and displaying the fields in field combination in the predetermined display format on the map.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a crop cultivation support method according to an embodiment;

FIG. 2 is a block diagram of a hardware configuration of a crop cultivation support apparatus according to the embodiment;

FIG. 3 is a diagram depicting an example of the contents of a field property master;

FIG. 4 is a diagram depicting an example of the contents of a crop record master;

FIG. 5 is a diagram depicting an example of a condition input screen;

FIG. 6 is a block diagram of an example of a functional configuration of the crop cultivation support apparatus;

FIG. 7 is a diagram depicting an example of the contents of a suitable-field determination master;

FIG. 8 is a diagram depicting an example of the contents of a filter condition table;

FIG. 9 is a diagram depicting an example of the contents of an evaluation results table;

FIG. 10 is a diagram depicting an example of the contents of a score master;

FIG. 11 is a flowchart of a procedure of a cultivation support process of the crop cultivation support apparatus according to the embodiment;

FIGS. 12 and 13 are flowcharts of an example of a procedure of a suitable-field judgment process at step S1105;

FIG. 14 is a flowchart of a procedure of an available field judgment process at step S1106;

FIG. 15 is a flowchart of an example of a procedure of a combination determination process at step S1109;

FIGS. 16 and 17 are flowcharts of a field selection process of the crop cultivation support apparatus; and

FIGS. 18A, 18B, 19A and 19B are diagrams depicting a field selection screen.

### DESCRIPTION OF EMBODIMENTS

Preferred embodiments of the disclosed crop cultivation support method and crop cultivation support apparatus will be described in detail with reference to the accompanying drawings.

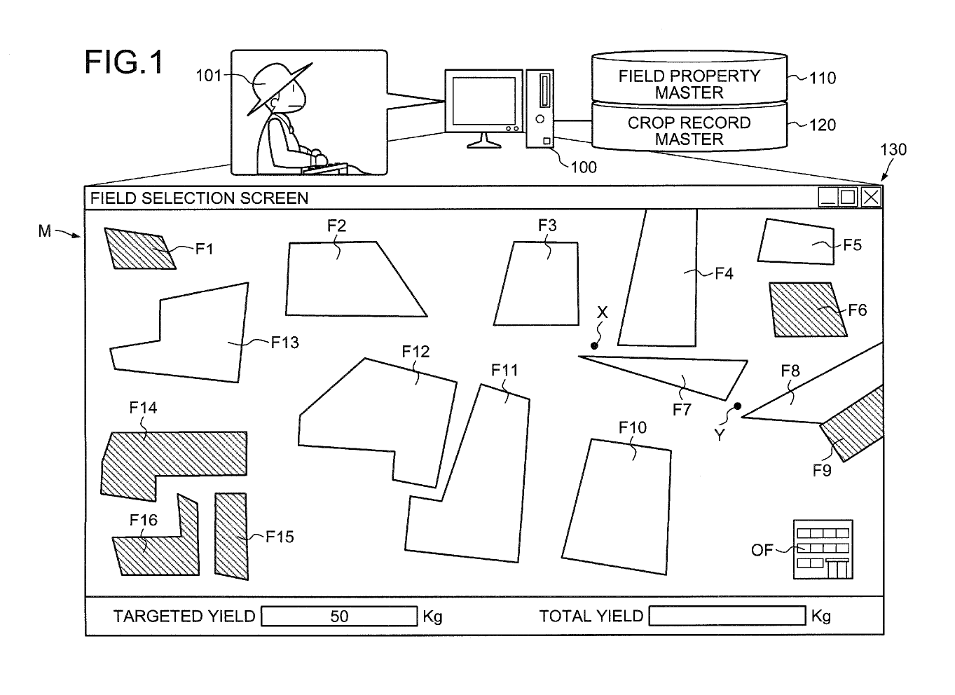

FIG. 1 is a diagram depicting an example of the crop cultivation support method according to an embodiment. As depicted in FIG. 1, a crop cultivation support apparatus 100 includes a field property master 110 and a crop record master 120, and is a computer supporting crop planning.

The crop cultivation support apparatus 100 has a screen displaying dispersed fields on a map M. In this example, the map M is a scaled figure depicting on a plane, a portion of or all of the fields managed by a user. The user is involved in agricultural operations and is, for example, a farm manager managing multiple fields.

A field is farmland for cultivating and raising crops. An indoor farm such as a so-called plant farm may also be included as a field. Fields, for example, are divided according to differences in terrain, exposure to sunlight, soil properties, etc. Terrain may include, for example, flat areas, mountainous areas, hills, low-lying land, marshy areas, etc. Exposure to sunlight is, for example, classified according to degree to which the ground surface is exposed to direct sunlight. Soil properties include, for example, soil texture, drainage, water supply capacity, difficulty of plowing, etc.

Crops are, for example, agricultural products such as grains and vegetables grown on farms, etc. Cultivation is the growing of crops in a field such as on a farm. Farm work is work related to cultivating and growing crops, and includes, for example, sowing seeds, plowing, applying fertilizer, preparing soil, weeding, thinning, re-applying fertilizer, ridging, harvesting, etc.

Here, an example of a procedure of a cultivation support process of the crop cultivation support apparatus 100 according to the embodiment will be described. In this example, description will be given taking fields F1 to F16 as an example of dispersed fields on the map M.

(1) The crop cultivation support apparatus 100 receives, via an input operation by the user 101, an input of conditions related to a crop (designated crop) that is to be cultivated. Conditions (crop conditions) related to the designated crop include, for example, a category, a sub-category, cultivation season, cultivation period, targeted yield, etc. of the designated crop.

A category is the type of crop and includes, for example, cabbage and carrots. A sub-category is a type among the same category. For example, a sub-category of cabbage may be autumn/winter cabbage, winter cabbage, and spring cabbage. Cultivation season refers to a system indicating a combination of conditions and technology when the designated crop is cultivated. Cultivation season includes, for example, spring sowing and cultivation, summer sowing and cultivation, autumn sowing and cultivation, winter sowing and cultivation.

A cultivation period is, for example, a period during which the designated crop is cultivated and may specified as, for example, Dec. 1, 2009 to Mar. 31, 2010. A targeted yield is the required crop yield and may be, for example, specified as a weight such as 50 [kg], 1 [ton], etc.

(2) The crop cultivation support apparatus 100 receives, via an input operation by the user 101, an input of conditions (suitable-field conditions) related to fields suitable for cultivation of the designated crop and include, for example, conditions related to the terrain, the degree of exposure to sunlight, the soil properties, etc. of a suitable field.

(3) The crop cultivation support apparatus 100, from among the fields F1 to F16 on the map M, retrieves a set of fields to be cultivation candidates of the designated crop, based on the properties of each of the fields F1 to F16. A property of a field is, for example, the terrain, the degree of exposure to sunlight, the soil properties, etc. of the field. For example, if “terrain ‘flat area’” is input as a suitable-field condition, the crop cultivation support apparatus 100 retrieves fields whose terrain is a “flat area”, from among the fields F1 to F16.

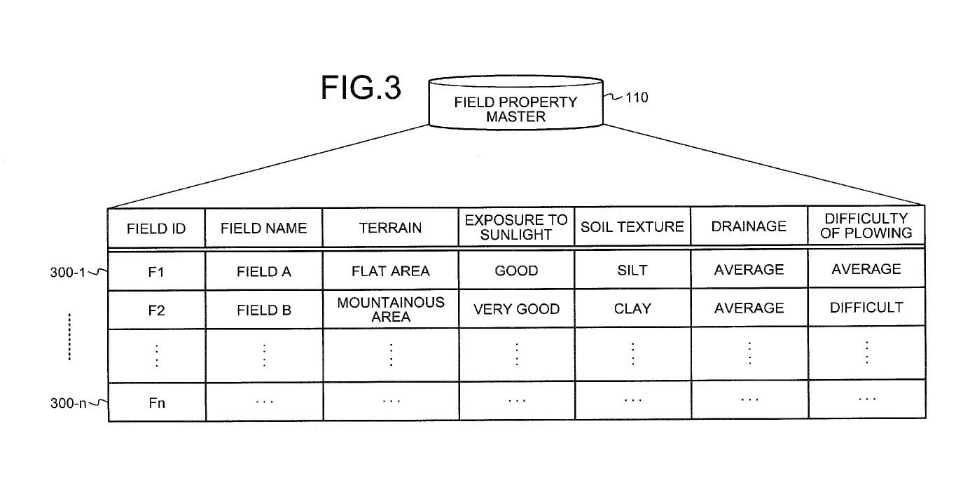

Field properties are, for example, stored in the field property master 110. The field property master 110 will be described in detail with reference to FIG. 3.

(4) The crop cultivation support apparatus 100, from among the set of retrieved fields, determines a field combination that can satisfy the targeted yield of the designated crop, based on an estimated yield of the designated crop, for each retrieved field. An estimated yield of a field is a yield estimated based on records of past yields when the designated crop was cultivated in the field.

For example, by selecting arbitrary fields from among the retrieved set of fields, the crop cultivation support apparatus 100 determines a combination of fields whose total estimated yield satisfies the targeted yield. Here, description will be given taking, as an example, a case in which a combination of the fields F1, F6, F9, and F14 to F16 have been selected as a field combination satisfying the targeted yield.

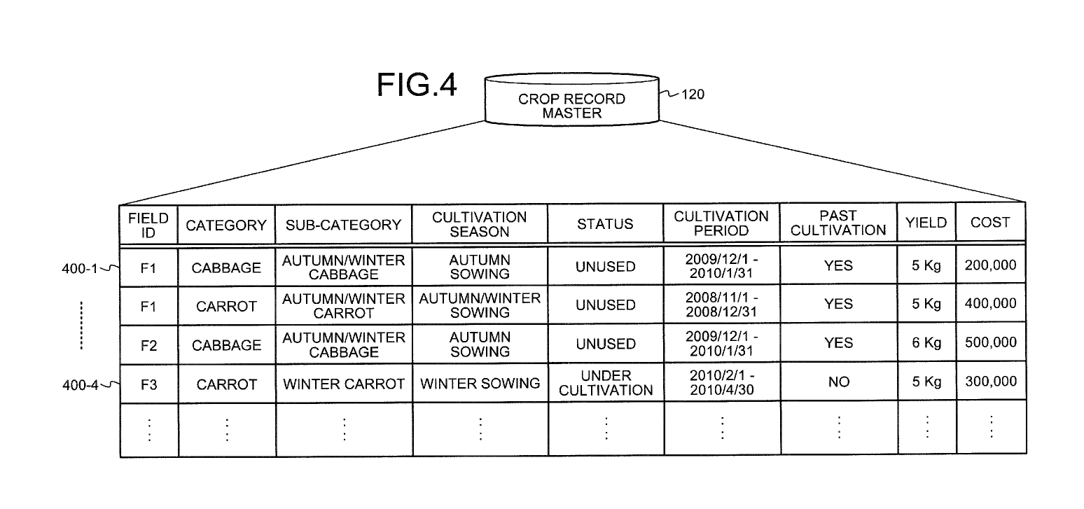

The estimated yield of a field is, for example, stored in the crop record master 120. The crop record master 120 will be described in detail with reference to FIG. 4.

(5) The crop cultivation support apparatus 100 changes the display format of each of the fields among the determined field combination to a predetermined display format that is different from the display format of the other fields F1 to F16 and displays on the map M, the fields whose format has been changed to the predetermined display format. For example, the crop cultivation support apparatus 100 displays a field selection screen 130 in which the displayed color of a graphics object on the map M displaying each of the fields in the determined field combination, has been changed to a predetermined color. In the figure, the change in color is indicated by hatching.

The field selection screen 130 is a screen for selecting fields to cultivate the designated crop, from among the dispersed fields F1 to F16 on the map M. In the field selection screen 130, graphics objects representing the fields F1, F6, F9, F14 to F16 of the field combination satisfying the targeted yield of “50 Kg” of the designated crop are displayed with hatching. In the figure, an office OF is a place where the user 101 waits and where seed/seedlings, fertilizers, chemicals, equipment, etc. are stored.

Through the field selection screen 130, the user 101 can intuitively determine, from among the dispersed fields F1 to F16 on the map M, a combination of fields satisfying the targeted yield of the designated crop and suitable for cultivation of the designated crop. Further, the user 101 can intuitively determine the positions of each of the dispersed fields on the map M as well as distances between fields, and between the fields and the office OF.

For example, if the cultivated crop has to be frequently checked on, the selection of a field that is a close distance to the office OF is desirable with a consideration of transit costs. In such a case, through the field selection screen 130, the user 101 can intuitively determine that among fields F1 to F16, the field F9 is a close distance to the office OF and can select the field F9.

Further, if the same crop or if crops having cultivation periods that are close are cultivated, a selection of fields within a close proximity to one another is desirable to facilitate work efficiency. In such a case, through the field selection screen 130, the user 101 can intuitively determine that among the fields F1 to F16, the fields F14 to F16 are in close proximity to one another and can select the fields F14 to F16.

If, for example, an obstacle (e.g., harvested crop, a tractor, etc.) limiting transit through a point X and a point Y on the map M is present, transit costs from the office OF to the field F6 may increase, and work efficiency with respect to cultivation in the field F6 may drop. Through the field selection screen 130, the user 101 can take such circumstances into consideration and determine whether to select the field F6 as a field for cultivating the designated crop.

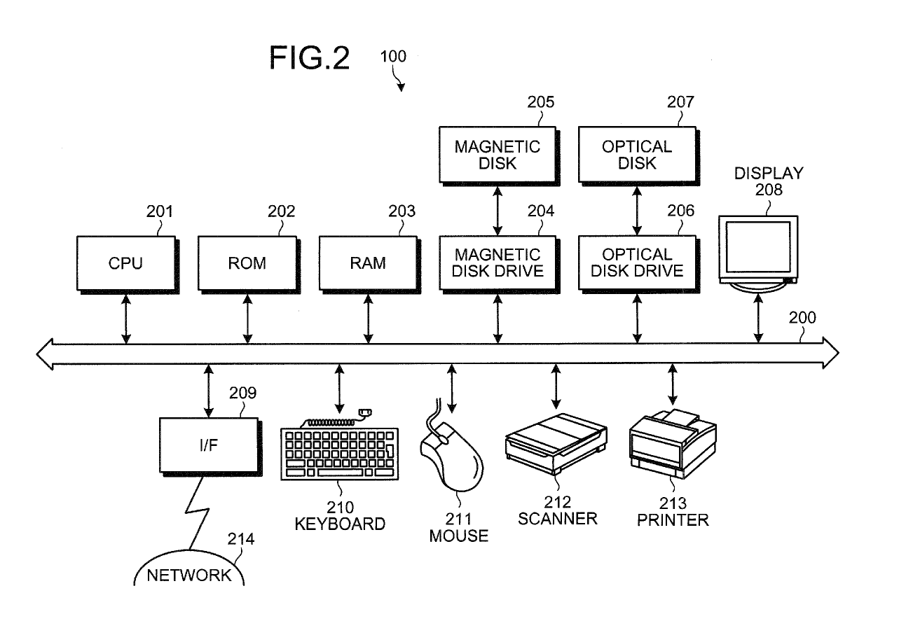

FIG. 2 is a block diagram of a hardware configuration of the crop cultivation support apparatus according to the embodiment. As depicted in FIG. 2, the crop cultivation support apparatus 100 includes a central processing unit (CPU) 201, a read-only memory (ROM) 202, a random access memory (RAM) 203, a magnetic disk drive 204, a magnetic disk 205, an optical disk drive 206, an optical disk 207, a display 208, an interface (I/F) 209, a keyboard 210, a mouse 211, a scanner 212, and a printer 213, respectively connected by a bus 200.

The CPU 201 governs overall control of the cultivation support apparatus. The ROM 202 stores therein programs such as a boot program. The RAM 203 is used as a work area of the CPU 201. The magnetic disk drive 204, under the control of the CPU 201, controls the reading and writing of data with respect to the magnetic disk 205. The magnetic disk 205 stores therein data written under control of the magnetic disk drive 204.

The optical disk drive 206, under the control of the CPU 201, controls the reading and writing of data with respect to the optical disk 207. The optical disk 207 stores therein data written under control of the optical disk drive 206, the data being read by a computer.

The display 208 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 208.

The I/F 209 is connected to a network 214 such as a local area network (LAN), a wide area network (WAN), and the Internet through a communication line and is connected to other apparatuses through the network 214. The I/F 209 administers an internal interface with the network 214 and controls the input/output of data from/to external apparatuses. For example, a modem or a LAN adaptor may be employed as the I/F 209.

The keyboard 210 includes, for example, keys for inputting letters, numerals, and various instructions and performs the input of data. Alternatively, a touch-panel-type input pad or numeric keypad, etc. may be adopted. The mouse 211 is used to move the cursor, select a region, or move and change the size of windows. A track ball or a joy stick may be adopted provided each respectively has a function similar to a pointing device.

The scanner 212 optically reads an image and takes in the image data into the cultivation support apparatus. The scanner 212 may have an optical character recognition (OCR) function as well. The printer 213 prints image data and text data. The printer 213 may be, for example, a laser printer or an ink jet printer.

The contents of the field property master 110 and the crop record master 120 of the crop cultivation support apparatus 100 will be described. The field property master 110 and the crop record master 120 are, for example, is stored in a storage device such as the ROM 202, the RAM 203, the magnetic disk 205, and the optical disk depicted in FIG. 2.

FIG. 3 is a diagram depicting an example of the contents of the field property master. In FIG. 3, the field property master 110 has fields for field IDs, field names, terrain, exposure to sunlight, soil textures, drainage, and difficulty of plowing and by setting information into each of the fields, stores the information as records, field property data 300-1 to 300-n.

Field IDs are identifiers of the fields F1 to Fn under management. In the description hereinafter, an arbitrary field among the fields F1 to Fn is indicated as “field Fi”, where (i=1, 2, . . . , n). A field name is the name of a field Fi. Terrain is the terrain of the field Fi. Exposure to sunlight indicates the state of the exposure to sunlight of the field Fi. The exposure to sunlight is categorized into 5 states, “very good”, “good”, “average”, “poor”, and “very poor” depending on the state of the exposure of the field Fi to sunlight.

The soil texture is categorized into 5 types, “silt”, “sand”, “clay”, “coarse sand”, and “volcanic ash” and is a soil property of the field Fi. The soil texture is categorized into the 5 types based on the ratio of various types of particles making up the soil of the field Fi. Drainage is the capacity of the field Fi to drain off unnecessary or harmful water. Drainage is categorized into 5 levels, “extremely good”, “very good”, “average”, “poor”, and “extremely poor”, based on differences in capacity. The difficulty of plowing indicates the difficulty of plowing and weeding the field Fi. The difficulty of plowing is categorized into 5 levels, “extremely difficult”, “difficult”, “average”, “easy”, and “extremely easy”, based on differences in difficulty.

Taking the field property data 300-1 as one example, for the field F1, a field name of “field A”, a terrain of “flat area”, a state of exposure to sunlight of “good”, a soil texture of “silt”, a drainage capacity of “average”, and a difficulty of plowing of “average” are stored.

FIG. 4 is a diagram depicting an example of the contents of the crop record master. In FIG. 4, the crop record master 120 has fields for field IDs, categories, sub-categories, cultivation season, statuses, periods, past cultivation, yields and costs, and by setting information into the fields, stores crop history data as records (e.g., crop history data 400-1 to 400-4).

A field ID is the identifier of a field Fi. A category is the category of a crop. The sub-category is the sub-category of the crop. Cultivation season indicates the cultivation season of a crop. The status is information indicating the cultivation status of the field Fi. In the case of an unused state in which no crop is cultivated in the field Fi, the status of the field Fi indicates “unused”. If a crop is under cultivation in the field Fi, the status of the field Fi indicates “under cultivation”. If cultivation is planned for the field Fi, the status of the field Fi indicates “cultivation planned”.

A period is the period of crop cultivation in the field Fi. If the status of the field Fi is “unused”, the period is a past period when a crop was cultivated in the field Fi. If the status of the field Fi is “under cultivation”, the period is the current period of the crop under cultivation in the field Fi. If the status of the field Fi is “cultivation planned”, the period is the period of the crop to be cultivated in the field Fi.

Past cultivation is information indicating whether a crop has been cultivated in a field Fi. The crop in this case is the crop identified by the category field, the sub-category field, the cultivation season field of the same record. If the crop has been cultivated in the field Fi, the past cultivation indicates “yes” and if the crop has not been cultivated in the field Fi, the past cultivation indicates “no”.

A yield is an estimated yield of the crop to be harvested in the field Fi. If the past cultivation is “yes”, the yield is a value that is based on a past yield of the crop in the field Fi. If the past cultivation is “no”, the yield is a value that is based on a past yield of the crop in another field having the same properties as the field Fi.

A cost is an estimated cost for cultivating the estimated yield in the field Fi. The cost is indicated by, for example, a total of the costs for seeds/seedlings, fertilizers, chemicals, equipment, labor, etc. to cultivate a unit yield per unit area of the field Fi. With consideration of transit costs for checking on the crop, the cost may include a transit cost that is based on the distance from the office OF to the field Fi.

Crop history data in the crop record master 120 is present for each group of “field ID, category, sub-category, and cultivation season”. In other words, even for the same field, if combinations of “category, sub-category, and cultivation season” differ, differing crop history data are stored as separate records in the crop record master 120.

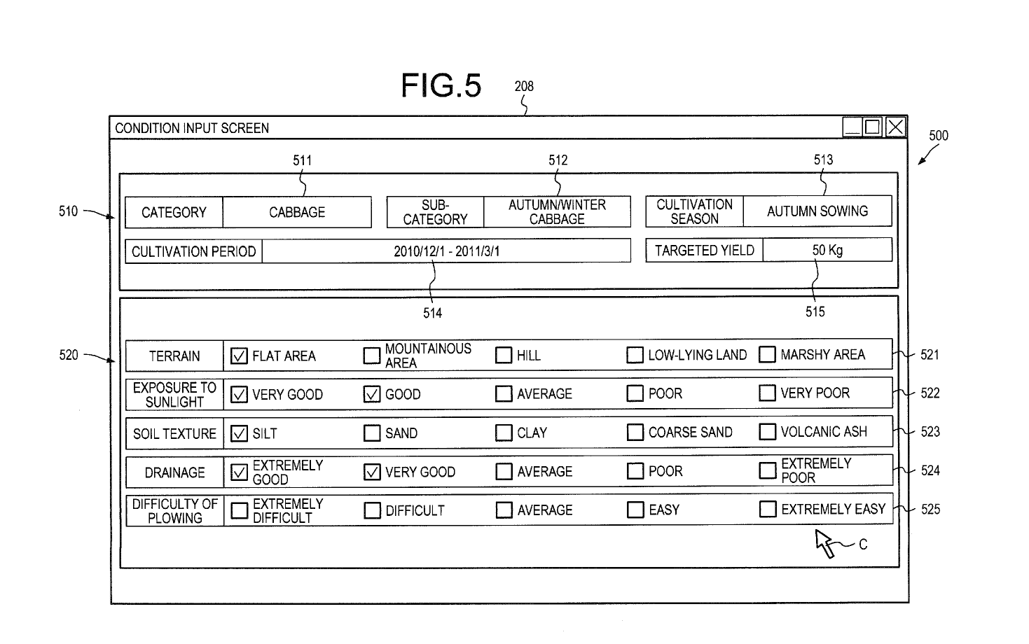

With reference to FIG. 5, a condition input screen 500 displayed on the display 208 when crop conditions related to a designated crop and suitable-field conditions related to a field suitable for cultivating the designated crop are input.

FIG. 5 is a diagram depicting an example of a condition input screen. In FIG. 5, the display 208 of the crop cultivation support apparatus 100 displays the condition input screen 500, which includes a box 510 for inputting crop conditions and a box 520 for inputting suitable-field conditions.

The box 510 includes boxes 511 to 515. The box 511 is a box for inputting the category of the designated crop. The box 512 is a box for inputting the sub-category of the designated crop. The box 513 is a box for inputting the cultivation season of the designated crop. The box 514 is a box for inputting the cultivation period of the designated crop. The box 515 is a box for inputting the targeted yield of the designated crop.

The box 520 includes boxes 521 to 525. The box 521 is a box for inputting the terrain of a field suitable for cultivating the designated crop. The box 522 is a box for inputting the exposure to sunlight state of a field suitable for cultivating the designated crop. The box 523 is a box for inputting the soil texture of a field suitable for cultivating the designated crop. The box 524 is a box for inputting the drainage capacity of a field suitable for cultivating the designated crop. The box 525 is a box for inputting the difficulty of plowing of a field suitable for cultivating the designated crop.

In the condition input screen 500, a cursor C is moved and the boxes 511 to 515 are clicked by a user input operation of the keyboard 210 and/or the mouse 211 depicted in FIG. 2, whereby crop conditions can be input. In the example depicted in FIG. 5, as crop conditions, “cabbage” in the box 511, “autumn/winter cabbage” in the box 512, “autumn sowing and cultivation” in the box 513, “Dec. 1, 2010 to Mar. 1, 2011” in the box 514, and “50 Kg” in the box 515 have been input.

In the condition input screen 500, via a user input operation of the keyboard 210 and/or the mouse 211 depicted in FIG. 2, the cursor C is moved and check buttons in the boxes 521 to 525 are clicked, whereby suitable-field conditions can be input. Here, by clicking the check buttons in the boxes 521 to 525, multiple conditions may be input.

In the example depicted in FIG. 5, as suitable-field conditions, “flat area” in the box 521, “very good” and “good” in the box 522, “silt” in the box 523, in “extremely good” and “very good” in the box 524 have been input. If multiple conditions have been input in the same box, each of the conditions is suitable for cultivation of the designated crop.

In the box 525, none of the check buttons have been clicked and no level for the difficulty of plowing of a field suitable for cultivation of the designated crop has been input. In this case, the difficulty of plowing is not taken into consideration as a suitable-field condition of a field suitable for cultivation of the designated crop.

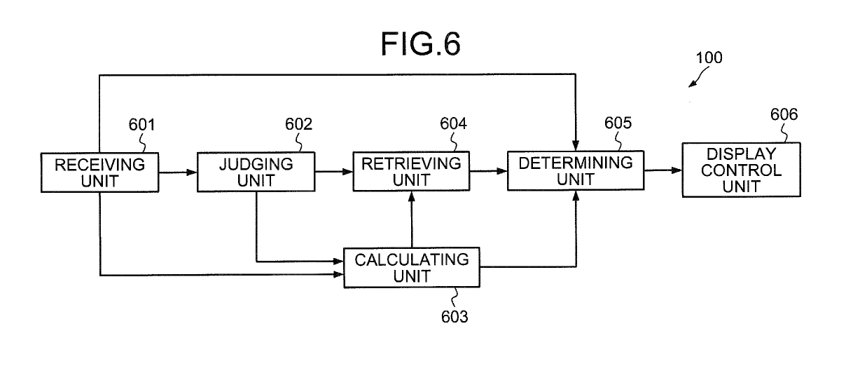

FIG. 6 is a block diagram of an example of a functional configuration of the crop cultivation support apparatus. In FIG. 6, the crop cultivation support apparatus 100 includes a receiving unit 601, a judging unit 602, a calculating unit 603, a retrieving unit 604, a determining unit 605, and a display control unit 606. Each functional unit (the receiving unit 601 to the display control unit 606), for example, is implemented by executing on the CPU 201, a program stored in a storage device such as the ROM 202, the RAM 203, the magnetic disk 205, and the optical disk 207 depicted in FIG. 2, or by the I/F 209. Processing results of the functional units, unless otherwise specified, are stored to a storage device such as the RAM 203, the magnetic disk 205, and the optical disk 207.

The receiving unit 601 has a function of receiving input of crop conditions related to a designated crop. For example, in the condition input screen 500 depicted in FIG. 5, the receiving unit 601 receives crop conditions input via a user input operation of the keyboard 210 and/or the mouse 211 depicted in FIG. 2.

The receiving unit 601 has a further function of receiving input of suitable-field conditions related to a field suitable for cultivation of the designated crop. For example, in the condition input screen 500, the receiving unit 601 receives suitable-field conditions input via a user input operation of the keyboard 210 and/or the mouse 211 depicted in FIG. 2.

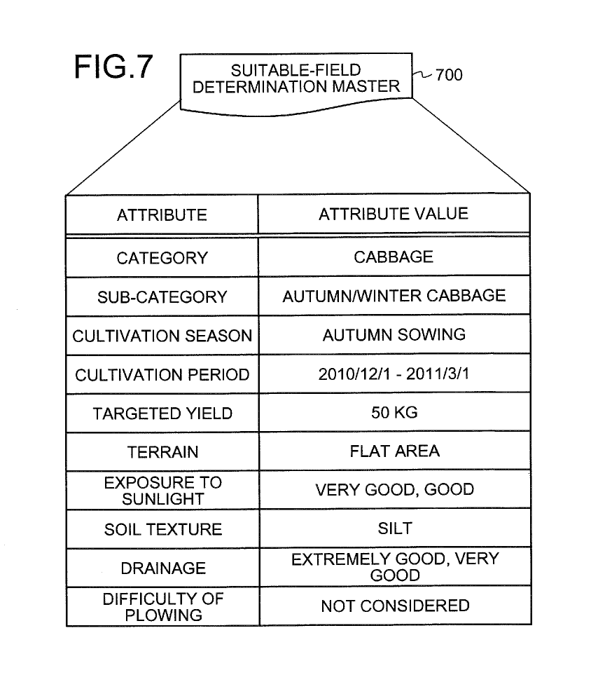

Input crop conditions and suitable-field conditions, for example, are stored to a suitable-field determination master 700 depicted in FIG. 7. The suitable-field determination master 700, for example, is implemented by a storage device such as the RAM 203, the magnetic disk 205 and the optical disk 207. Here, the suitable-field determination master 700 will be described.

FIG. 7 is a diagram depicting an example of the contents of the suitable-field determination master. In FIG. 7, the suitable-field determination master 700 has attribute values for each attribute. Attributes, for example, are “category”, “sub-category”, “cultivation season”, “period” and “targeted yield” input as crop conditions, and “terrain”, “exposure to sunlight”, “soil texture”, “drainage” and “difficulty of plowing” input as suitable-field conditions in the condition input screen 500.

Attributes for which no attribute value is input indicates that the attribute is “not taken into consideration”. In this example, since the difficulty of plowing of a field suitable for cultivation of the designated crop has not been input in the condition input screen 500, the attribute value of the attribute “difficulty of plowing” is “not taken into consideration”.

The reference of description returns to FIG. 6. The judging unit 602 has a function of judging for each field Fi among the fields F1 to Fn, whether the field Fi meets the conditions for cultivating the designated crop, based on the properties of the field Fi. In this example, the properties of the field Fi are, for example, the terrain, the state of exposure to sunlight, the soil texture, the drainage, the water supply capacity, and the difficulty of plowing of the field Fi.

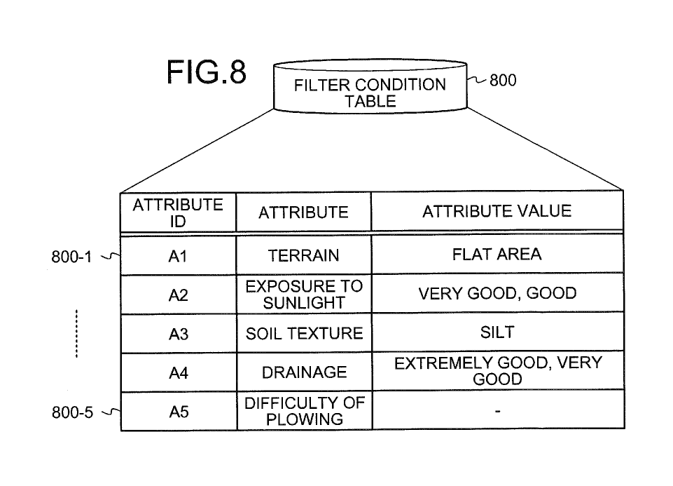

For example, the judging unit 602 extracts attributes related to suitable-field conditions from the suitable-field determination master 700 depicted in FIG. 7 to generate a filter condition table 800 depicted in FIG. 8. Here, the filter condition table 800 will be described.

FIG. 8 is a diagram depicting an example of the contents of the filter condition table. In FIG. 8, the filter condition table 800 has fields for attribute IDs, attributes, and attribute values and by setting information into the fields, stores as records, attribute data 800-1 to 800-5 related to suitable-field conditions. An attribute ID is an identifier of an attribute related to a suitable-field condition. An attribute is the name of the attribute related to the suitable-field condition. An attribute value is the value of the attribute related to the suitable-field condition.

In the example of the suitable-field determination master 700 depicted in FIG. 7, attributes A1 to A5 are “terrain”, “exposure to sunlight”, “soil texture”, “drainage”, and “difficulty of plowing”. Thus, “flat area”, “very good,good”, “silt”, “extremely good, very good” and “-(null)” are set in the filter condition table 800 as attribute values of the attributes A1 to A5.

The reference of description returns to FIG. 6. The judging unit 602 selects an arbitrary field Fi from among the fields F1 to Fn. The judging unit 602 extracts the field property data 300-i of the selected field Fi, from the field property master 110 depicted in FIG. 3.

The judging unit 602 selects an arbitrary attribute (“attribute Aj”) (j=1, 2, . . . , m) from among the attributes (“attributes A1 to Am”) related to suitable-field conditions in the filter condition table 800 depicted in FIG. 8. In the example depicted in FIG. 8, “m” of the attribute Am is “m=5”.

The judging unit 602 refers to the filter condition table 800 and identifies the attribute value of the selected attribute Aj. Here, the identified attribute value of the attribute Aj is a suitable-field condition related to the attribute Aj. Therefore, in the description hereinafter, an attribute value (of the attribute Aj) identified from the filter condition table 800 will be referred to as “a suitable-field condition for attribute Aj”.

The judging unit 602 refers to the extracted field property data 300-i of the field Fi and identifies the attribute value of the attribute Aj of the field Fi. For example, the judging unit 602 identifies as the attribute value of the attribute Aj, the information set in the field corresponding to the attribute Aj of the field property data 300-i.

The judging unit 602 judges whether the attribute value of the attribute Aj of the field Fi is included in the suitable-field condition for the attribute Aj. Herein, if the attribute value of the attribute Aj of the field Fi is included in the suitable-field condition for the attribute Aj, the judging unit 602 judges that the attribute value of the attribute Aj of the field Fi satisfies the suitable-field condition for the attribute Aj.

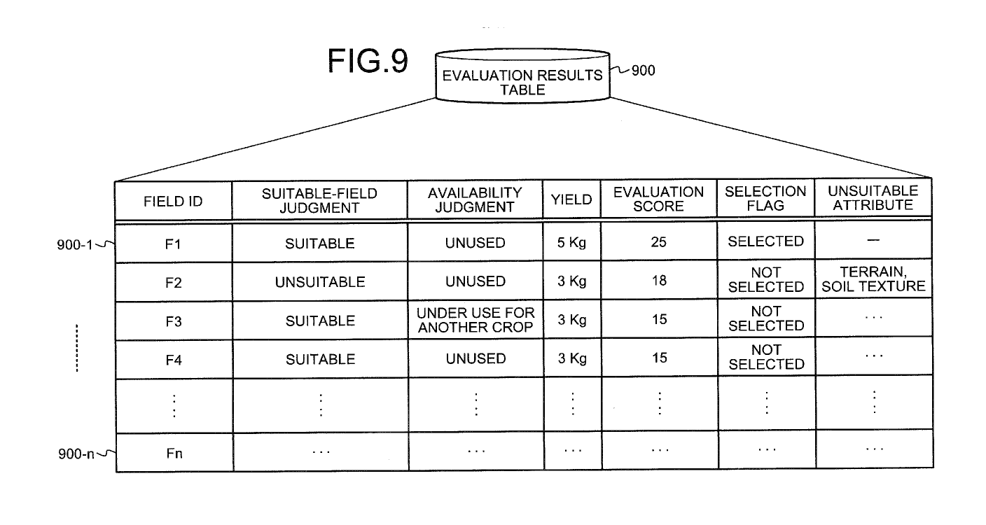

On the other hand, if the attribute value of the attribute Aj of the field Fi is not included in the suitable-field condition for the attribute Aj, the judging unit 602 judges that the attribute value of the attribute Aj of the field Fi does not satisfy the suitable-field condition for the attribute Aj. If the attribute value of the attribute Aj of the field Fi does not satisfy the suitable-field condition for the attribute Aj, the attribute name of the attribute Aj is set in an unsuitable attribute field for the field Fi in an evaluation results table 900 depicted in FIG. 9 described hereinafter.

The selection of an attribute Aj related to the suitable-field condition in the filter condition table 800 is, for example, recursively performed until unselected attributes that have yet to be selected among the attributes A1 to Am have been exhausted. As a result, for each attribute Aj among the attributes A1 to Am related to the suitable-field condition, whether the attribute value of the attribute Aj of the field Fi satisfies the suitable-field condition for the attribute Aj is judged.

Upon judging that the attribute values of the attributes A1 to Am respectively satisfy the suitable-field conditions of the attributes A1 to Am, the judging unit 602 judges the field Fi to satisfy the conditions of a suitable field for cultivating the crop. On the other hand, if the attribute values of the attributes A1 to Am of the field Fi do not satisfy any one or more of the suitable-field conditions of the attributes A1 to Am, the judging unit 602 judges that the field Fi does not satisfy the conditions of a field suitable for cultivation of the crop.

The selection of the field Fi is recursively repeated until unselected fields that have yet to be selected from among the fields F1 to Fn have been exhausted. As a result, for each field Fi among the fields F1 to Fn, whether the field Fi satisfies the conditions of a field suitable for cultivation of the crop is judged.

Results of the judging process are, for example, stored to the evaluation results table 900 depicted in FIG. 9. The evaluation results table 900 is, for example, implemented by a storage device such as the RAM 203, the magnetic disk 205 and the optical disk 207. Here, the evaluation results table 900 will be described.

FIG. 9 is a diagram depicting an example of the contents of the evaluation results table. In FIG. 9, the evaluation results table 900 has fields for field IDs, suitable-field judgments, availability judgments, yields, evaluation scores, selection flags, and unsuitable attributes and by setting information into each field, stores evaluation results 900-1 to 900-n as records.

The field ID is the identifier of a field Fi. The suitable-field judgment is information indicating the judgment result of whether the field Fi satisfies the conditions of a field suitable for cultivation of the designated crop. The availability judgment is information indicating the cultivation state of the field Fi. The yield is the estimated yield for the designated crop to be harvested from the field Fi. The evaluation score is an index indicating the suitability of the field Fi as a field suitable for cultivation of the designated crop.

The selection flag is information indicating the selection state of the field Fi. The unsuitable attribute is information indicating that the attribute Aj of the field Fi has been judged to not satisfy the suitable-field condition for the attribute Aj. The availability judgment, evaluation score and selection flag will be described in detail hereinafter.

For example, if the field Fi has been judged to satisfy the conditions of a suitable field for the cultivation of the crop, in the suitable-field judgment field of the field Fi “suitable” is set. On the other hand, if the field Fi has been judged to not satisfy the conditions of a field suitable for cultivation of the crop, in the suitable-field judgment field of the field Fi “unsuitable” is set.

Here, an example of the information set in the fields of the evaluation results table 900 will be described taking a case in which the field F1 is selected from among the fields F1 to Fn by the judging unit 602 as an example.

If the field F1 has been selected, the judging unit 602 judges for each attribute Aj among the attributes A1 to A5 related to the suitable-field condition, whether the attribute value of the attribute Aj of the field F1 satisfies the suitable-field condition for the attribute Aj. In this example, since the attribute values of the attributes A1 to A5 of the field F1 respectively satisfy the suitable-field conditions of the attributes A1 to A5, the field F1 is judged to satisfy the conditions of a field suitable for cultivating the designated crop.

As a result, in the suitable-field judgment field of the field F1 in the evaluation results table 900, “suitable” is set and in the unsuitable attribute field, “−” is set. As for the attribute A5 for which no attribute value has been set in the filter condition table 800, irrespective of the contents of the attribute value of the attribute A5 for the field F1, the suitable-field condition of the attribute A5 is judged to be satisfied.

The estimated yield of the designated crop of the field F1 is identified from the crop record master 120. For example, from the crop record master 120, the judging unit 602 extracts the crop history data in which “F1” is set in the field ID field, and the category, the sub-category, and the cultivation season of the designated crop are set in the fields for the category, the sub-category, and the cultivation season.

The category, the sub-category, and the cultivation season of the designated crop are identified from the suitable-field determination master 700. In this example, since the category, sub-category and the cultivation season of the designated crop are “cabbage”, “autumn/winter cabbage”, and “autumn sowing and cultivation”, the crop history data 400-1 is extracted from the crop record master 120. As a result, the yield of “5 Kg” in the crop history data 400-1 is set in the yield field for the field F1 in the evaluation results table 900.

The reference of description returns to FIG. 6. The judging unit 602 judges whether the field Fi is an available field. Here, available field is an unused field in which no crop is being cultivated. For example, the judging unit 602 refers to the suitable-field determination master 700 and identifies the cultivation period of the designated crop. Next, the judging unit 602 extracts the crop history data of the field F1 from the crop record master 120.

The judging unit 602 compares the period of each extracted crop history data with the cultivation period of the designated crop and judge whether crop history data having a period overlapping the cultivation period of the designated crop is present. Here, if none of the crop history data has a period overlapping the cultivation period of the designated crop, the judging unit 602 judges that the field Fi is an available field.

On the other hand, if the crop history data having a period overlapping the cultivation period of the designated crop designated crop is present, the judging unit 602 judges that the field Fi is not an available field. In this case, if the status of the crop history data is “under cultivation”, the judging unit 602 may judge that the field Fi has been used for the cultivation of another crop. Further, if the status of the crop history data is “cultivation planned”, the judging unit 602 may judge that the field Fi has been planned for the cultivation of another crop.

Further, the status of the crop history data having a period that overlaps the cultivation period of the designated crop may be “under cultivation” and “cultivation planned”. In this case, “under cultivation” may be given priority and the judging unit 602 may judge that field Fi has been used for the cultivation of another crop.

The judgment results are, for example, stored to the evaluation results table 900. For example, if the field Fi is judged to be an available field, in the availability judgment field for the field Fi in the evaluation results table 900, “available” is set. Further, if the field Fi has been judged to be used for the cultivation of another crop, in availability judgment field of the field Fi in the evaluation results table 900, “under use for another crop” is set. If the field Fi has been judged to be planned for the cultivation of another crop, in the availability judgment field of the field Fi in the evaluation results table 900, “cultivation planned” is set.

The calculating unit 603 has a function of calculating an index value indicative of the suitability of the field Fi as a field suitable for cultivation of the designated crop, based on the properties of the field Fi. For example, the calculating unit 603 extracts from the field property master 110, the field property data 300-i of the field Fi. The calculating unit 603 refers to the field property data 300-i and identifies the attribute value of each attribute Aj of the field Fi.

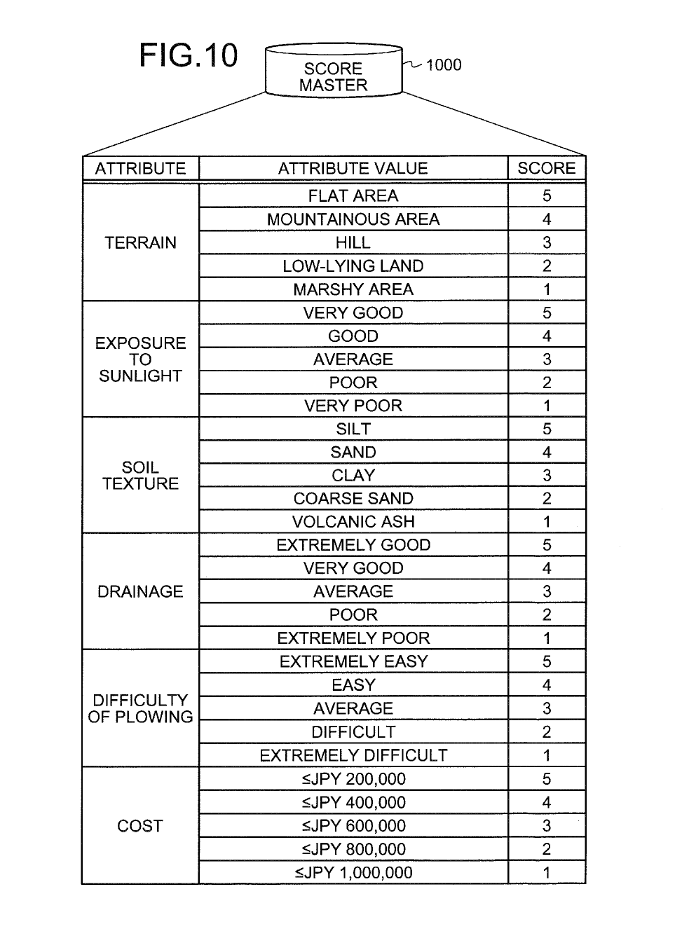

The calculating unit 603 refers to a score master 1000 depicted in FIG. 10 and identifies the score of each attribute Aj of the field Fi. The calculating unit 603 calculates the index indicative of the suitability of the field Fi as a field suitable for the cultivation of the designated crop, by summing the scores of each attribute Aj of the field Fi.

The score master 1000 is information indicating the score of each attribute value of the attributes Aj representing conditions of a field suitable for cultivation of the designated crop. The score master 1000 is, for example, preliminarily generated for each combination of “category,sub-category and cultivation season” and is stored in a storage device such as the ROM 202, the RAM 203, the magnetic disk 205, and the optical disk depicted in FIG. 2.

Here, the contents of the score master 1000 are described taking “cabbage, autumn/winter cabbage,autumn sowing and cultivation” as an example of a “category,sub-category and cultivation season”.

FIG. 10 is a diagram depicting an example of the contents of the score master. In FIG. 10, the score master 1000 stores for each attribute Aj indicating a condition for a field suitable for cultivation of the designated crop specifying “cabbage, autumn/winter cabbage, autumn sowing and cultivation”, the score of each attribute value of the attributes Aj. Here, for each attribute Aj, the more suitable the attribute value is for the cultivation of the designated crop, the higher the score.

Taking “terrain” as an example, “flat area” is given 5 points, “mountainous area” is 4 points, “hills” is 3 points, “low-lying land” is given 2 points, and “marshy area” is given 1 point. In other words, the “terrain” of a field suitable for the cultivation of the designated crop is “flat area→mountainous area→hills→low-lying land→marshy”, sequentially.

For example, for the field F1, the attribute value of the attribute A1, “terrain”, is “flat area”; the attribute value of the attribute A2, “exposure to sunlight”, is “good”; the attribute value of the attribute A3, “soil texture”, is “silt”; the attribute value of the attribute A4, “drainage”, is “average”; and the attribute value of the attribute A5, “difficulty of plowing”, is “average”. Therefore, the scores of the attributes A1 to A5 of the field F1 are “5, 4, 5, 3, and 3”, respectively.

The cost in the case of cultivating the designated crop specified for “cabbage, autumn/winter cabbage, autumn sowing and cultivation” in field F1 is “200,000” (refer to FIG. 4). Thus, the score of the cost for the field F1 is “5”. Therefore, the evaluation scores (index) indicating the suitability of the field Fi as a field suitable for the cultivation of the designated crop is “25=5+4+5+3+3+5”.

The reference of the description returns to FIG. 6. The retrieving unit 604 has a function of retrieving a set of fields as cultivation candidates for the designated crop from the fields F1 to Fn, based on the judgment results. In the description hereinafter, the set of fields that are cultivation candidates for the designated crop will be indicated as “fields F[1] to F[n]” and an arbitrary field among the fields F[1] to F[n] will be indicated as “field F[i]”, where (i=1, 2, . . . , n).

For example, the retrieving unit 604 refers to the evaluation results table 900 and retrieves the fields F[1] to F[n] having a suitable-field judgment field in which “suitable” is set (first retrieval technique). As a result, fields satisfying the conditions for a field suitable for the cultivation of the designated crop can be retrieved as cultivation candidates, the fields F[1] to F[n].

The retrieving unit 604 may refer to the evaluation results table 900 and retrieve the fields F[1] to F[n] having an availability judgment field in which “available” is set (second retrieval technique). As a result, available fields that are not currently under cultivation can be retrieved as cultivation candidates, the fields [1] to F[n].

Further, the retrieving unit 604 may refer to the evaluation results table 900 and retrieve the fields F[1] to F[n] having an evaluation score field in which an evaluation score of a threshold X or greater has been set (third retrieval technique). As a result, fields for which the suitability as a field for cultivation of the designated crop is a prescribed value or greater can be retrieved as cultivation candidates, the fields F[1] to F[n].

The threshold X is, for example, preliminarily set and stored in a storage device such as the ROM 202, the RAM 203, the magnetic disk 205, and the optical disk depicted in FIG. 2. Further, for example, the average of the evaluation scores of the fields Fi in the evaluation results table 900 may be used as the threshold X.

The retrieving unit 604 may combine multiple retrieval techniques among the first to the third retrieval techniques to retrieve cultivation candidates for the designated crop, the fields F[1] to F[n].

For example, the retrieving unit 604 may refer to the evaluation results table 900 and retrieve the fields F[1] to F[n] having a suitable-field judgment field in which “suitable” is set and an availability judgment field in which “available” is set (first retrieval technique+second retrieval technique). As a result, available fields that satisfy conditions for a suitable field for cultivating the designated crop and that are not currently under cultivation can be retrieved as cultivation candidates, the fields F[1] to F[n].

The determining unit 605 has a function of determining a combination of fields that satisfy the targeted yield of the designated crop, based on the estimated yield of each field F[i] among the retrieved fields F[1] to F[n]. For example, the determining unit 605 selects an arbitrary field F[i] from among the fields F[1] to F[n].

The determining unit 605 refers to the evaluation results table 900 and identifies the yield of the field F[i] (yield q[i]). The determining unit 605 calculates a provisional yield sum Qv of the identified yields q[i]. The provisional yield sum Qv is a total of the estimated yields of the designated crop. The determining unit 605 judges if the provisional yield sum Qv is greater than or equal to the targeted yield (targeted yield Qt). The targeted yield Qt is the targeted yield (e.g., 50 Kg) stored in the suitable-field determination master 700.

Here, if the provisional yield sum Qv is less than the targeted yield Qt, the determining unit 605 selects an unselected field F[i] that has not yet been selected from among the fields F[1] to F[n] and recursively repeats the series of operations. On the other hand, if the provisional yield sum Qv is greater than or equal to the targeted yield Qt, the determining unit 605 determines the combination of fields selected from among the fields F[1] to F[n], to be a field combination satisfying the targeted yield Qt of the designated crop.

As a result, a field combination satisfying the targeted yield Qt of the designated crop can be determined from among the fields F[1] to F[n].

When selecting a field F[i], the determining unit 605 may refer to the evaluation results table 900 and selects the field F[i] having the greatest evaluation score among the fields F[1] to F[n]. As a result, a field F[i] having a high evaluation score can be preferentially selected as a field to make up the combination of fields satisfying the targeted yield Qt of the designated crop.

The determination results are, for example, stored to the evaluation results table 900. For example, in the selection flag field of each of the fields of the determined combination in the evaluation results table 900, “provisionally selected” is set.

The display control unit 606 has a function of controlling the display 208, changing the display format of each of the fields of the determined combination, to a predetermined display format different from the display format of the other fields F1 to Fn, and displaying the fields for which the format has been changed, on the map M. A change in the display format includes, for example, a change in the color or the hatching in which graphics objects representing fields in the map M are displayed, and labeling graphics objects with an arbitrary symbol or character string.

For example, according to each value set in the selection flag fields in the evaluation results table 900, the display control unit 606 changes the color in which the graphics objects representing fields are displayed on the map M. As a result, the dispersed fields F1 to Fn on the map M can be categorized according to the value set in the selection flag field.

In the description hereinafter, as one example, the display color of a graphics object representing a field in which “not selected” is set in the selection flag field in the evaluation results table 900 will be assumed to be a color C1. Further, the display color of a graphics object representing a field in which “provisionally selected” is set in the selection flag field in the evaluation results table 900 will be assumed to be a color C2.

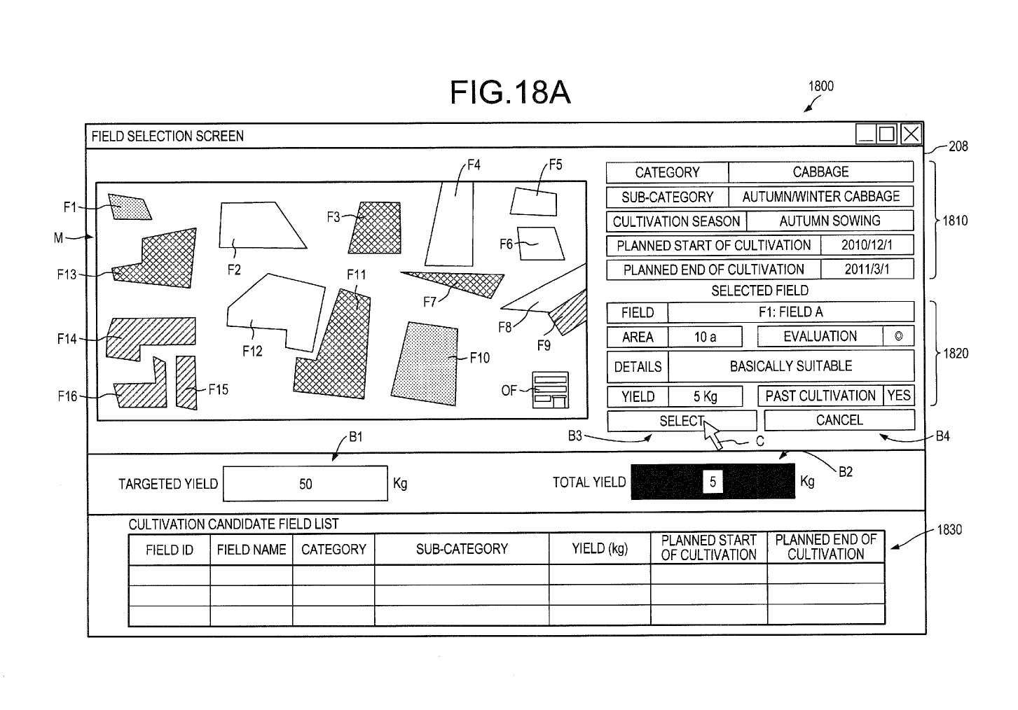

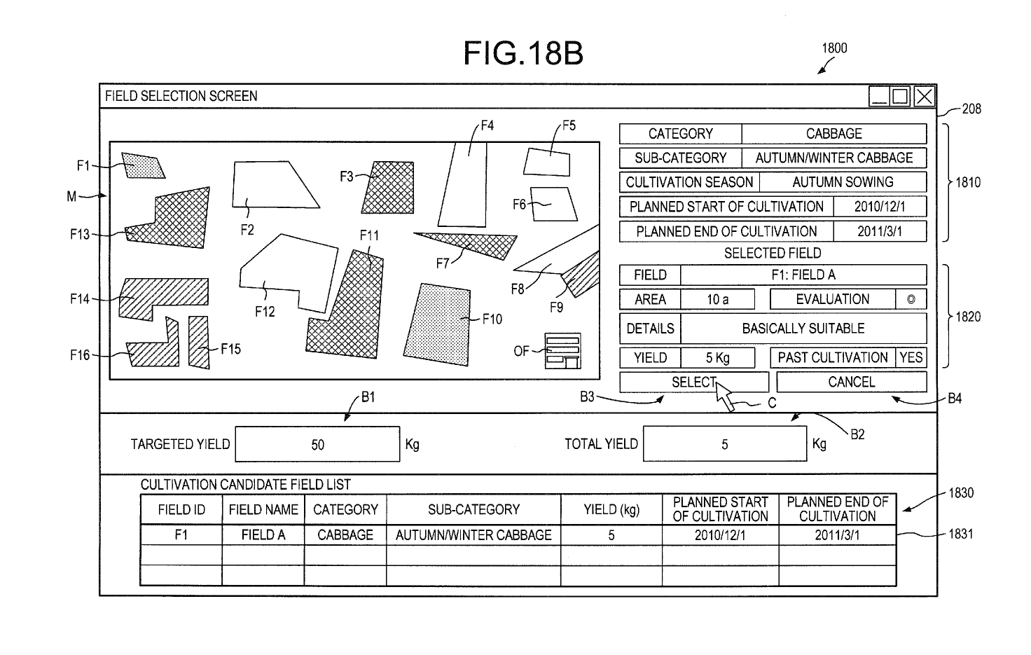

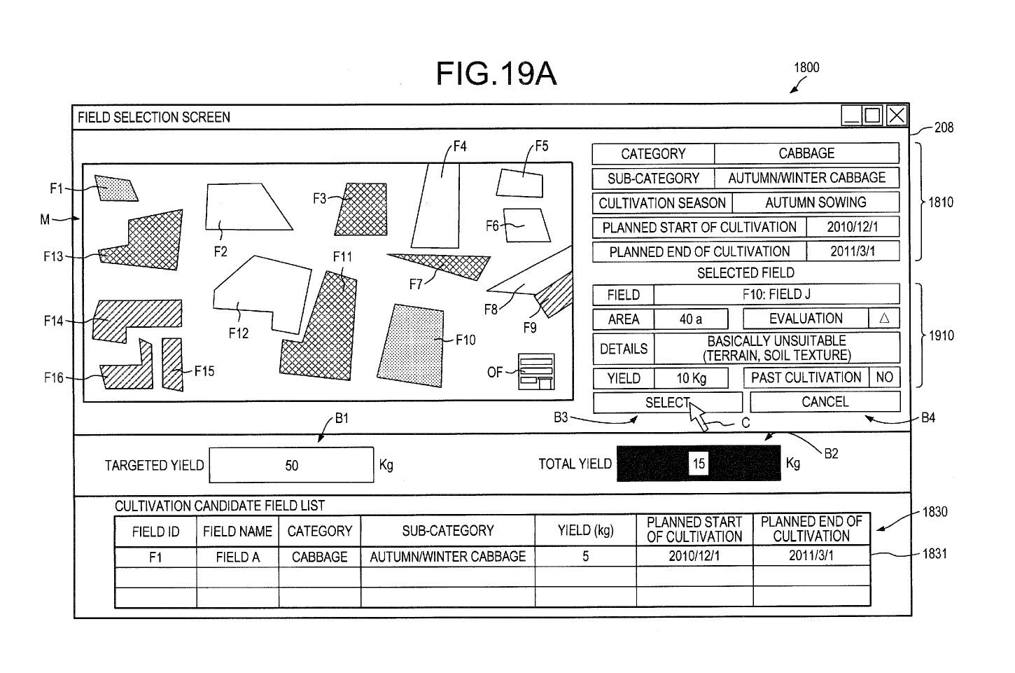

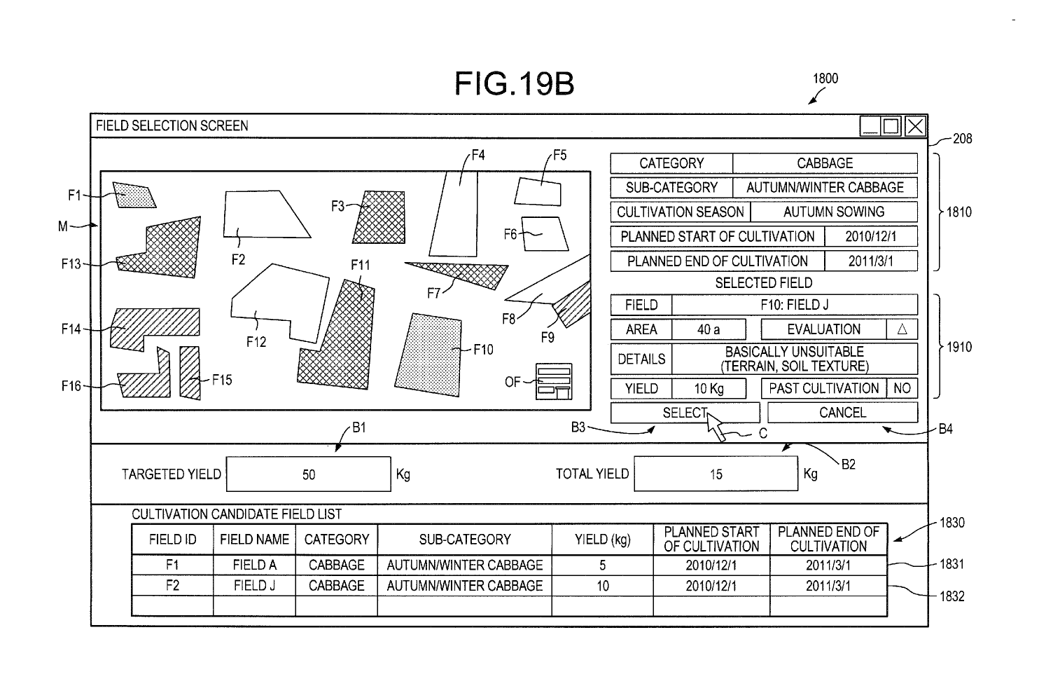

The display color of a graphics object representing a field in which “selected” is set in the selection flag field in the evaluation results table 900 will be assumed to be a color C3. Further, the display color of a graphics object representing a field in which “under use for another crop” or “cultivation planned” is set in the availability judgment flag field in the evaluation results table 900 is assumed to be a color C4. An example of a screen displayed on the display 208 will be described with reference to FIGS. 18 and 19.

The receiving unit 601 has a function of receiving a select instruction for a given field that is for cultivating the designated crop and among the fields F1 to Fn. For example, the receiving unit 601 receives the select instruction for the given field, via a user input operation of the keyboard 210 and/or the mouse 211 depicted in FIG. 2.

When a select instruction for a given field has been received, in the evaluation results table 900, “selected” is set in the selection flag field of the given field. As a result, for example, the display control unit 606 changes the display color of the graphics object representing the given field on the map M, to the color C3.

Further, when the select instruction for the given field is received, the determining unit 605 determines a field combination that satisfies a yield (differential yield Qd) that represents the difference of the estimated yield of the given field and the targeted yield Qt. For example, the determining unit 605 refers to the evaluation results table 900 and calculates an estimated yield total Q by summing the yields of the fields in which “selected” is set in the selection flag field. The estimated yield total Q is a variable representing the total estimated yield of the designated crop.

The determining unit 605 judges if the estimated yield total Q is greater than or equal to the targeted yield Qt. Here, if the estimated yield total Q is greater than or equal to the targeted yield Qt, for a group of records in the evaluation results table 900 in which the selection flag field of the record is set as “provisionally selected”, the determining unit 605 changes the selection flag to “not selected”.

As a result, for example, the display control unit 606 changes on the map M, the display color of each graphics object representing a field for which the selection flag has been changed from “provisionally selected” to “not selected”, from the color C2 to the color Cl. In other words, since the estimated yield total Q is greater than or equal to the targeted yield Qt, the process of recommending fields for the cultivation of the designated crop is ended.

On the other hand, if the estimated yield total Q is less than the targeted yield Qt, the determining unit 605 calculates the differential yield Qd representing the difference of the estimated yield total Q and the targeted yield Qt. The determining unit 605 refers to the evaluation results table 900 and determines a field combination satisfying the differential yield Qd.

For example, for a group of records in the evaluation results table 900 in which the selection flag field is set as “provisionally selected”, the determining unit 605 changes the selection flag to “not selected”. The determining unit 605 refers to the evaluation results table 900 and selects a field F[i] in which “not selected” is set in the selection flag field, from among the fields [1] to F[n]. The determining unit 605 refers to the evaluation results table 900 and identifies the yield q[i] of the field F[i]. The determining unit 605 adds the identified yield q[i] to the provisional yield sum Qv and judges if the resulting provisional yield sum Qv is greater than or equal to the differential yield Qd.

Here, if the provisional yield sum Qv is less than the differential yield Qd, the determining unit 605 selects an unselected field F[i] that has yet to be selected and repeats the series of operations. On the other hand, if the provisional yield sum Qv is greater than or equal to the differential yield Qd, the determining unit 605 determines the selected field combination to be a field combination satisfying the differential yield Qd.

As a result, a field combination satisfying the differential yield Qd representing the difference of the estimated yield total Q and the targeted yield Qt can be determined from among the fields F[1] to F[n].

If the selection flag of the given field for which the select instruction is received is “provisionally selected”, since among the determined combination, the remaining fields excluding the given field do not change, the determination process of determining a field combination that satisfies the differential yield Qd need not be performed. As a result, meaningless execution of the determination process can be eliminated, thereby reducing processing.

The receiving unit 601 has a function of receiving a cancel-selection instruction for the given field. For example, the receiving unit 601 receives a cancel-selection instruction for the given field via a user input operation of the keyboard 210 and/or the mouse 211 depicted in FIG. 2.

If a cancel-selection instruction for the given field has been received, in the evaluation results table 900, “not selected” is set in the selection flag field of the given field. As a result, for example, the display control unit 606 changes the display color of the graphics object representing the given field on the map M to the color C1.

Further, if a cancel-selection instruction for the given field has been received, the determining unit 605 refers to the evaluation results table 900 and calculates the estimated yield total Q by summing the yields of the fields having “selected” set in the selection flag field. The determining unit 605 judges if the estimated yield total Q is greater than or equal to the targeted yield Qt.

Here, if the estimated yield total Q is greater than or equal to the targeted yield Qt, for a group of records in the evaluation results table 900 in which the selection flag field is set as “provisionally selected”, the determining unit 605 changes the selection flag to “not selected”. As a result, for example, the display control unit 606 changes the display color of the graphics object representing on the map M, the field for which the selection flag has been changed from “provisionally selected” to “not selected”, from the color C2 to the color C1.

On the other hand, if the estimated yield total Q is less than the targeted yield Qt, the determining unit 605 calculates the differential yield Qd representing the difference of the estimated yield total Q and the targeted yield Qt. The determining unit 605 refers to the evaluation results table 900 and performs the determination process of determining a field combination satisfying the differential yield Qd.

The judging unit 602 may judge the suitability level of each of the fields F1 to Fn based on the evaluation scores of the fields F1 to Fn stored in the evaluation results table 900. A suitability level indicates the suitability of a field Fi as a field for cultivating the designated crop. Presenting the suitability level of each field Fi to the user during field selection can aid in judging the degree to which a field Fi is suitable for cultivating the designated crop.

For example, if the evaluation score of the field Fi is greater than or equal to a threshold α, the judging unit 602 regards the suitability level of the field Fi to be “A”. If the evaluation score of the field Fi is greater than or equal to a threshold β and is less than the threshold α, the judging unit 602 regards the suitability level of the field Fi to be “B”. Further, if the evaluation score of the field Fi is less than the threshold β, the judging unit 602 regards the suitability level of the field Fi to be “C”. If the field Fi is “under use for another crop” or “cultivation planned”, the judging unit 602 regards the suitability level of the field Fi to be “D”. The thresholds α and β, for example, are preliminarily set and stored in a storage device such as the ROM 202, the RAM 203, the magnetic disk 205, and the optical disk depicted in FIG. 2.

As a result, the suitability levels of the fields F1 to Fn can be categorized into 4 suitability levels and presented to the user. More specifically, for example, if the suitability level of the field Fi is “A”, “\textcircled{∘}” is displayed on the display 208 during field selection (refer to FIG. 18). If the suitability level of the field Fi is “B”, “∘” is displayed on the display 208 during field selection. If the suitability level of the field Fi is “C”, “Δ” is displayed on the display 208 during field selection (refer to FIG. 19). If the suitability level of the field Fi is “D”, “×” is displayed on the display 208 during field selection.

A procedure of the cultivation support process of the crop cultivation support apparatus 100 will be described.

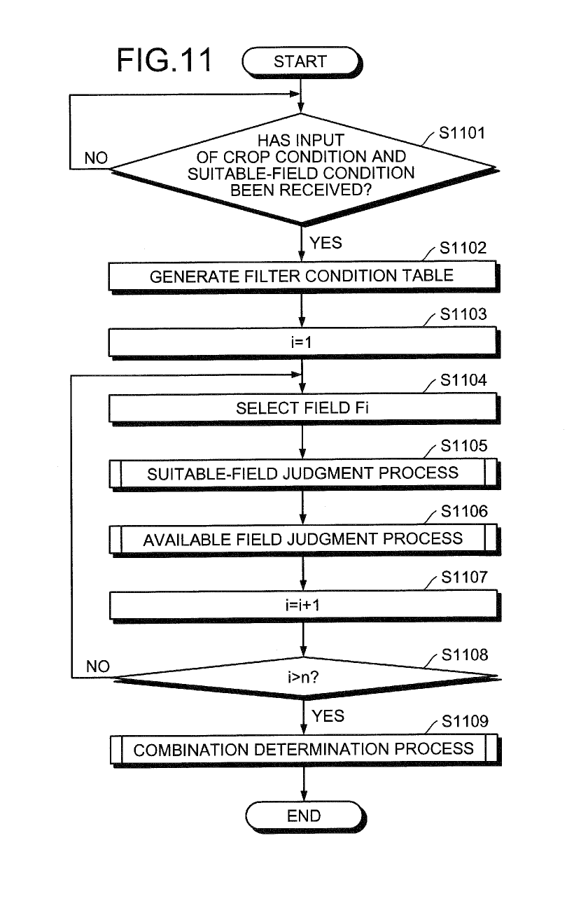

FIG. 11 is a flowchart of a procedure of the cultivation support process of the crop cultivation support apparatus according to the embodiment. In the flowchart depicted in FIG. 11, the crop cultivation support apparatus 100 judges whether input of a crop condition related to a designated crop and a suitable-field condition related to a field suitable for cultivation of the designated crop has been received by the receiving unit 601 (step S1101).

Here, the crop cultivation support apparatus 100 waits until a crop condition and a suitable-field condition have been input (step S1101: NO) and when input has been received (step S1101: YES), the judging unit 602 generates the filter condition table 800 (step S1102). The filter condition table 800 is generated by extracting from the suitable-field determination master 700, attributes related to the suitable-field condition.

The judging unit 602 sets “i” of the field Fi to “i=1” (step S1103), and selects the field Fi from among the fields F1 to Fn (step S1104). The judging unit 602 executes a suitable-field judgment process of judging whether the field Fi satisfies conditions of a field suitable for cultivation of the designated crop (step S1105).

The judging unit 602 executes an available field judgment process of judging whether the field Fi is an available field (step S1106). The judging unit 602 increments “i” of the field Fi (step S1107), and judges whether “i” greater than “n” (step S1108).

If “i” is less than or equal to “n” (step S1108: NO), the judging unit 602 returns to step S1104. On the other hand, if “i” is greater than “n” (step S1108: YES), the determining unit 605 executes a combination determination process of determining a field combination that satisfies the targeted yield of the designated crop (step S1109), ending the series of operations according to the flowchart.

Thus, a field combination satisfying the targeted yield Qt of the designated crop can be determined, the display format of each of the fields of the determined combination can be changed to a predetermined display format that differs from the display format of other fields, and the fields for which the display format has been changed can be displayed on the map M.

A procedure of the suitable-field judgment process at step S1105 depicted in FIG. 11 will be described.

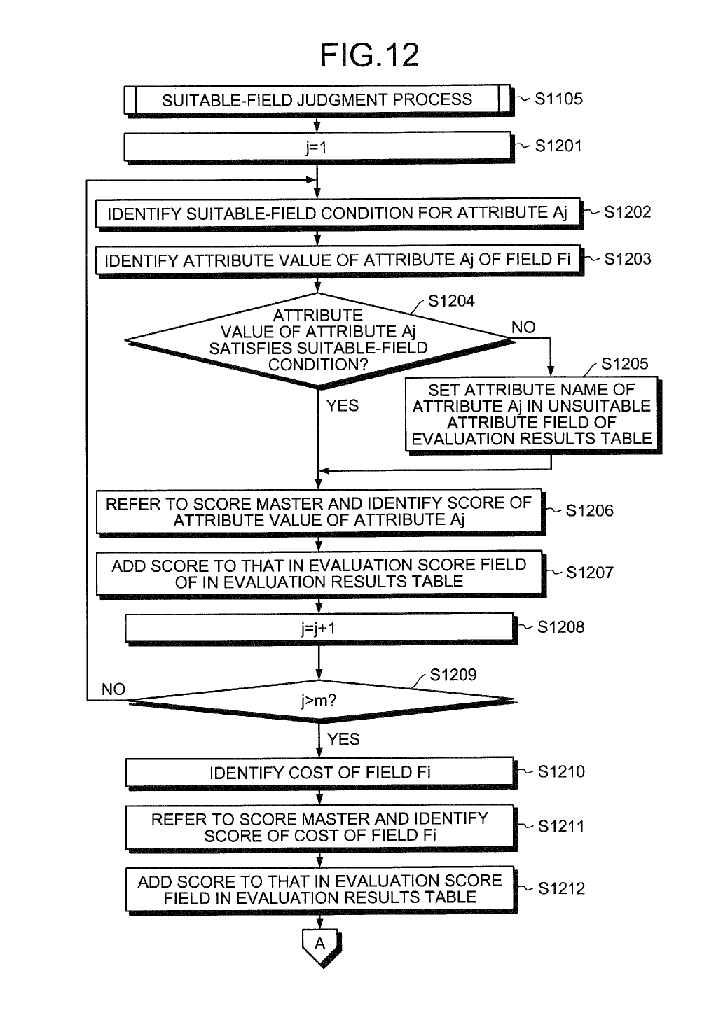

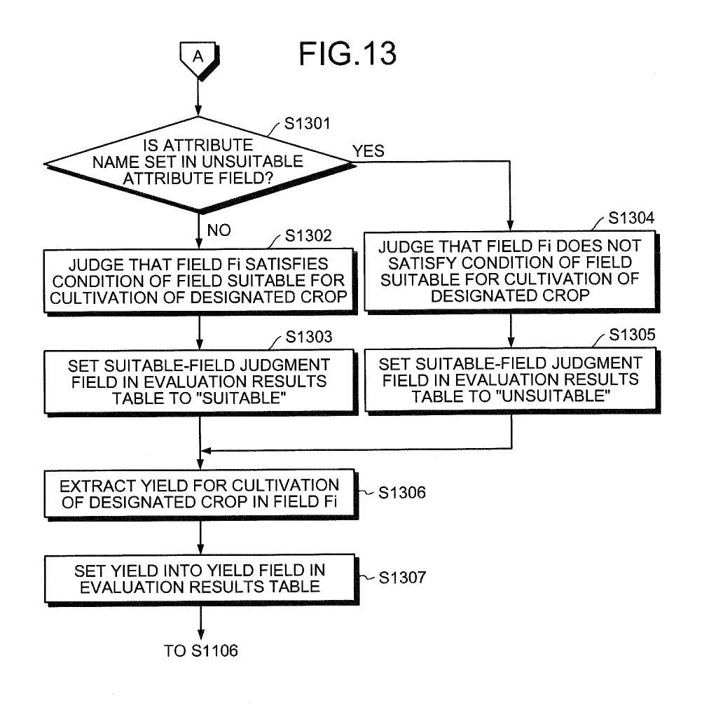

FIGS. 12 and 13 are flowcharts of an example of a procedure of the suitable-field judgment process at step S1105. In the flowchart depicted in FIG. 12, the judging unit 602 sets “j” of the attribute Aj related to the suitable-field condition in the filter condition table 800 to “j=1” (step S1201).

The judging unit 602 refers to the filter condition table 800 and identifies the suitable-field condition for the attribute Aj (step S1202). The judging unit 602 refers to the field property master 110 and identifies the attribute value of the attribute Aj of field Fi (step S1203).

The judging unit 602 judges whether the attribute value of the attribute Aj of field Fi satisfies the suitable-field condition for the attribute Aj (step S1204). If the suitable-field condition for the attribute Aj is not satisfied (step S1204: NO), in the evaluation results table 900, the judging unit 602 sets the attribute name of the attribute Aj in the unsuitable attribute field of the field Fi (step S1205), and transitions to step S1206.

On the other hand, if the suitable-field condition for the attribute Aj is satisfied (step S1204: YES), the calculating unit 603 refers to the score master 1000 and identifies the score of the attribute value of the attribute Aj of the field Fi (step S1206). The calculating unit 603 adds the score to that in the evaluation score field of the field Fi in the evaluation results table 900 (step S1207).

The judging unit 602 increments “j” of the attribute Aj (step S1208) and judges whether “j” is greater than “m” (step S1209). If “j” is less than or equal to “m” (step S1209: NO), the judging unit 602 returns to step S1202.

On the other hand, if “j” is greater than “m” (step S1209: YES), the calculating unit 603 refers to the crop record master 120 and identifies the cost of the field Fi (step S1210). The calculating unit 603 refers to the score master 1000 and identifies the score of the cost of the field Fi (step S1211). The calculating unit 603 adds the score to that in the evaluation score field of the field Fi in the evaluation results table 900 (step S1212), and transitions to step S1301 depicted in FIG. 13.

In the flowchart depicted in FIG. 13, the judging unit 602 judges whether in the evaluation results table 900, the attribute name is set in the unsuitable attribute field of the field Fi (step S1301).

If the attribute name is not set in the unsuitable attribute field (step S1301: NO), the judging unit 602 judges that the field Fi satisfies the condition of a field suitable for cultivation of the designated crop (step S1302). The judging unit 602 sets the suitable-field judgment field of the field Fi to “suitable” in the evaluation results table 900 (step S1303).

On the other hand, if the attribute name is set in the unsuitable attribute field (step S1301: YES), the judging unit 602 judges that the field Fi does not satisfy the condition of a field suitable for cultivation of the designated crop (step S1304). The judging unit 602 sets the suitable-field judgment field of the field Fi to “unsuitable” in the evaluation results table 900 (step S1305).

The judging unit 602 extracts from the crop record master 120, the yield for the cultivation of the designated crop in the field Fi (step S1306). The yield is the yield in the crop history data having “Fi” set in the field ID field, and having the sub-category and the cultivation season of the designated crop set in the category, sub-category, and cultivation season fields, respectively.

The judging unit 602 sets the extracted yield into the yield field for the field Fi in the evaluation results table 900 (step S1307), and transitions to step S1106 depicted in FIG. 11.

Thus, whether each of the fields Fi satisfies the suitable-field condition of a field suitable for cultivating the designated crop can be judged. Further, evaluation scores representing the suitability of each of the fields Fi as a field suitable for cultivating the designated crop can be calculated.

A procedure of the available field judgment process at step S1106 depicted in FIG. 11 will be described.

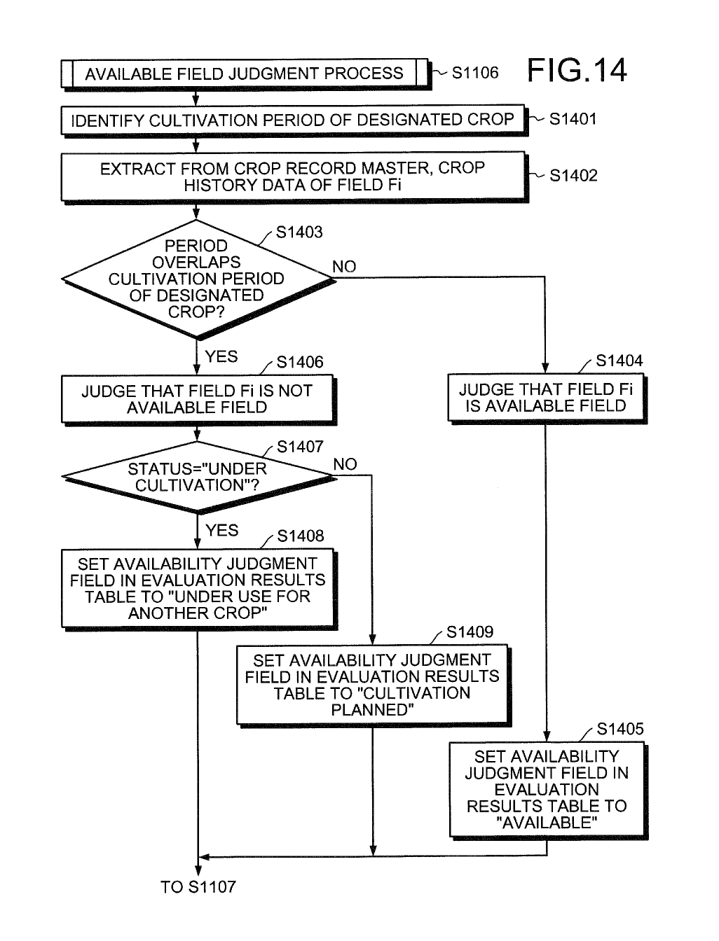

FIG. 14 is a flowchart of a procedure of the available field judgment process at step S1106. In the flowchart depicted in FIG. 14, the judging unit 602 refers to the suitable-field determination master 700 and identifies the cultivation period of the designated crop (step S1401).

The judging unit 602 extracts from the crop record master 120, the crop history data of the field Fi (step S1402). The judging unit 602 compares the period in the extracted crop history data and the cultivation period of the designated crop, and thereby judges whether crop history data in which the period indicated overlaps the cultivation period of the designated crop is present (step S1403).

If no such history data is present (step S1403: NO), the judging unit 602 judges that the field Fi is an available field (step S1404). The judging unit 602 sets the availability judgment field of the field Fi to “available” in the evaluation results table 900 (step S1405), and transitions to step S1107 depicted in FIG. 11.

On the other hand, if history data is present in which the period indicated overlaps the cultivation period of the designated crop (step S1403: YES), the judging unit 602 judges that the field Fi is not an available field (step S1406). The judging unit 602 judges whether the status indicated in the crop history data in which the period indicated overlaps the cultivation period of the designated crop is “under cultivation” (step S1407).

If the status is “under cultivation” (step S1407: YES), the judging unit 602 sets the availability judgment field of the field Fi to “under use for another crop” in the evaluation results table 900 (step S1408), and transitions to step S1107 depicted in FIG. 11.

On the other hand, if the status is not “under cultivation” (step S1407: NO), the judging unit 602 sets the availability judgment field of the field Fi to “cultivation planned” in the evaluation results table 900 (step S1409), and transitions to step S1107 depicted in FIG. 11.

Thus, available fields that are not currently being used for cultivation can be retrieved as cultivation candidates, the fields F[1] to F[n]. The available field judgment process may be executed before the suitable-field judgment process, whereby fields that are under cultivation or for which cultivation is planned can be excluded from being subject to the suitable-field judgment process and thereby enabling the processing load of the suitable-field judgment process to be decreased.

A procedure of the combination determination process at step S1109 depicted in FIG. 11 will be described.

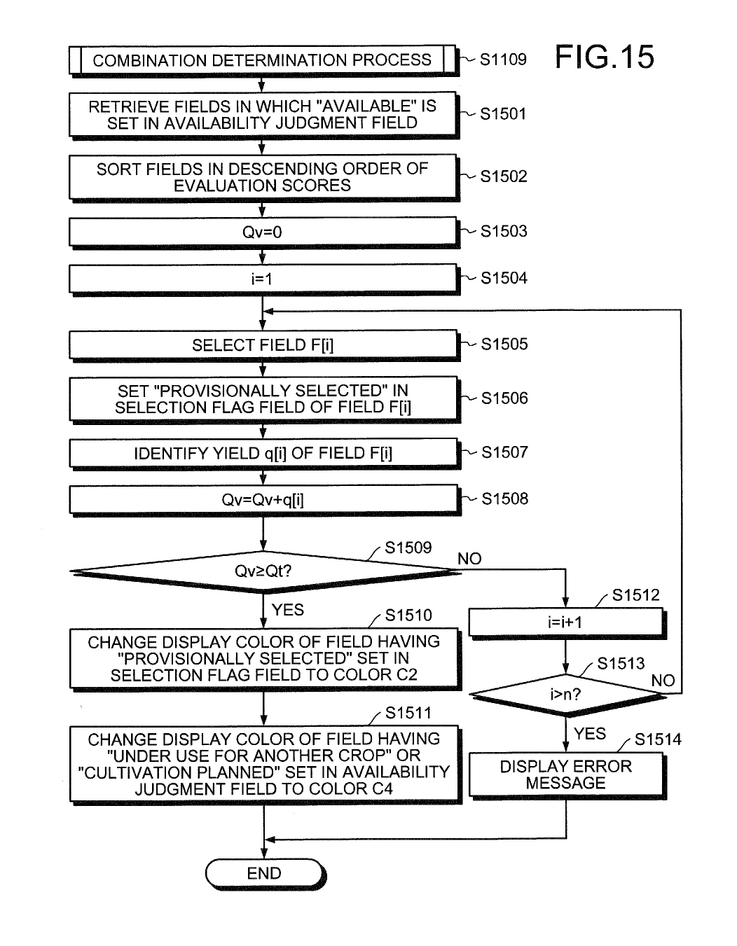

FIG. 15 is a flowchart of an example of a procedure of the combination determination process at step S1109. In the flowchart depicted in FIG. 15, the retrieving unit 604 refers to the evaluation results table 900 and retrieves fields in which “available” is set in the availability judgment field (step S1501).

The retrieving unit 604 refers to the evaluation results table 900 and sorts the retrieved fields in descending order of evaluation scores (step S1502). Herein, a set of fields after being sorted in descending order of evaluation scores is indicated as “fields F[1] to F[n]”.

The determining unit 605 sets the provisional yield sum Qv to “Qv=0” (step S1503) and sets “i” of F[i] to “i=1” (step S1504). The determining unit 605 selects the field F[i] from among the fields F[1] to F[n] (step S1505) and in the evaluation results table 900, sets “provisionally selected” in the selection flag field of the field F[i] (step S1506).

The determining unit 605 refers to the evaluation results table 900 and identifies the yield q[i] of the field F[i] (step S1507). The determining unit 605 adds the identified yield q[i] of the field F[i] to the provisional yield sum Qv (step S1508). The determining unit 605 judges if the provisional yield sum Qv is greater than or equal to the targeted yield Qt (step S1509).

If the provisional yield sum Qv is greater than or equal to the targeted yield Qt (step S1509: YES), the display control unit 606 controls the display 208 and changes the display color of the field having “provisionally selected” set in the selection flag field in the evaluation results table 900, to the color C2 (step S1510).

The display control unit 606 controls the display 208 and changes the display color of the field having “under use for another crop” or “cultivation planned” set in the availability judgment field in the evaluation results table 900, to the color C4 (step S1511), ending the series of operations according to the flowchart.

On the other hand, if the provisional yield sum Qv is less than the targeted yield Qt (step S1509: NO), the determining unit 605 increments “i” of the field F[i] (step S1512) and judges whether “i” is greater than “n” (step S1513).

If “i” is less than or equal to “n” (step S1513: NO), the determining unit 605 returns to step S1505. On the other hand, if “i” is greater than “n” (step S1513: YES), the display control unit 606 displays an error message on the display 208 (step S1514), ending the series of operations according to the flowchart.

Thus, a field combination that satisfies the targeted yield Qt can be determined from among the fields F[1] to F[n] in descending order of evaluation scores.

The error message displayed at step S1514 is a message indicating that a field combination satisfying the targeted yield of the designated crop cannot be formed. If an error message is displayed, for example, the targeted yield of the designated crop and/or search conditions for the fields F[1] to F[n] at step S1501 are changed and again, crop conditions and suitable-field conditions are input.

A procedure of a field selection process of the crop cultivation support apparatus 100 will be described.

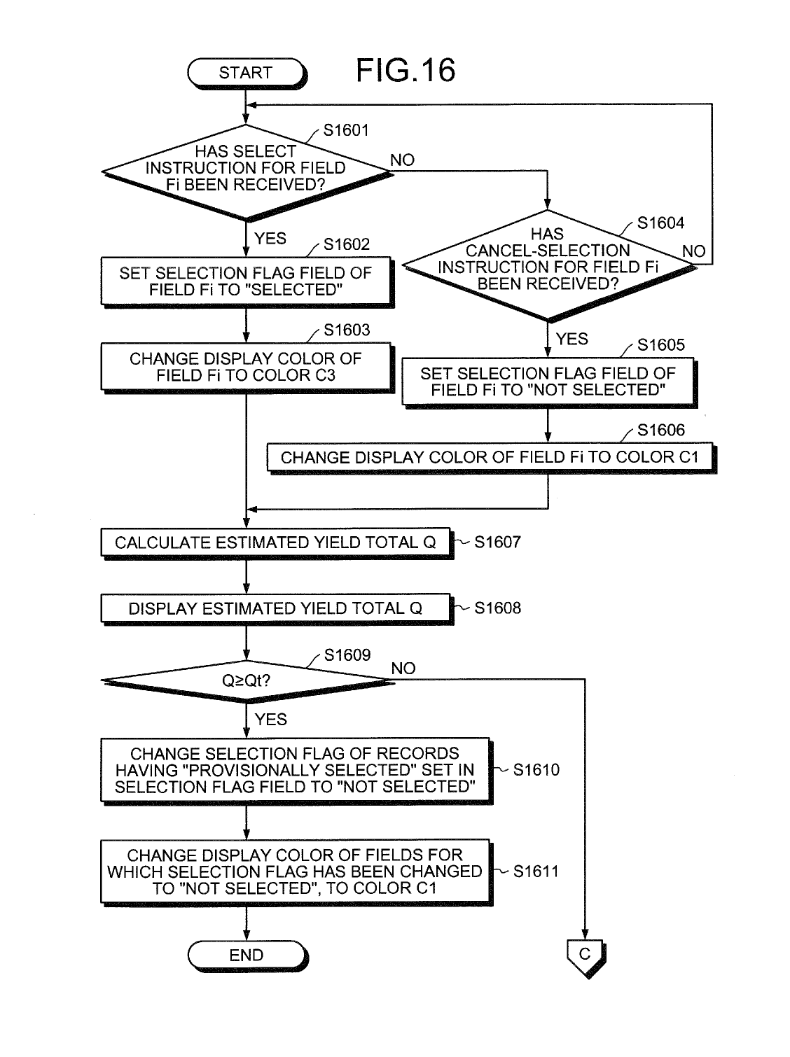

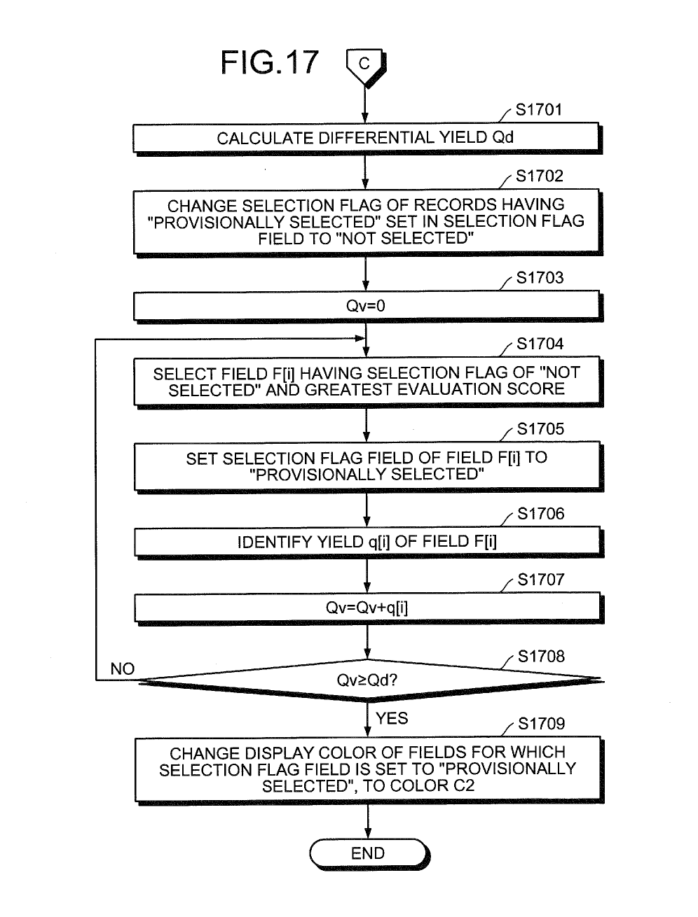

FIGS. 16 and 17 are flowcharts of the field selection process of the crop cultivation support apparatus. In the flowchart depicted in FIG. 16, the crop cultivation support apparatus 100 judges whether a select instruction for a field Fi that is for cultivating the designated crop and among the dispersed fields F1 to Fn on a map displayed on the display 208 has been received by the receiving unit 601 (step S1601).

If a select instruction for a field Fi has been received (step S1601: YES), the determining unit 605 sets the selection flag field of the field Fi in the evaluation results table 900 to “selected” (step S1602). The display control unit 606 controls the display 208, changes the display color of the field Fi to the color C3 (step S1603), and transitions to step S1607.

At step S1601, if no select instruction for a field Fi is received (step S1601: NO), the crop cultivation support apparatus 100 judges whether a cancel-selection instruction for a field Fi has been received by the receiving unit 601 (step S1604). If no cancel-selection instruction for a field Fi has been received (step S1604: NO), the crop cultivation support apparatus 100 returns to step S1601.

On the other hand, if a cancel-selection instruction for a field Fi has been received (step S1604: YES), the determining unit 605 sets the selection flag field of the field Fi in the evaluation results table 900 to “not selected” (step S1605). The display control unit 606 controls the display 208 and changes the display color of the field Fi to the color C1 (step S1606).

The determining unit 605 refers to the evaluation results table 900 and sums the yields of the fields having “selected” set in the selection flag field to thereby calculate the estimated yield total Q (step S1607). The display control unit 606 controls the display 208 and displays the calculated estimated yield total Q (step S1608).

The determining unit 605 judges if the estimated yield total Q is greater than or equal to the targeted yield Qt (step S1609). If the estimated yield total Q is greater than or equal to the targeted yield Qt (step S1609: YES), the determining unit 605 changes in the evaluation results table 900, the selection flag of the records having “provisionally selected” set in the selection flag field to “not selected” (step S1610).

The display control unit 606 controls the display 208 and changes the display color of the fields for which the selection flag has been changed to “not selected”, to the color C1 (step S1611), ending the series of operations according to the flowchart.

At step S1609, if the estimated yield total Q is less than the targeted yield Qt (step S1609: NO), the crop cultivation support apparatus 100 transitions to step S1701 depicted in FIG. 17.

In the flowchart depicted in FIG. 17, the determining unit 605 calculates the differential yield Qd representing the difference of the estimated yield total Q and the targeted yield Qt (step S1701). The determining unit 605 changes in the evaluation results table 900, the selection flag of the records having “provisionally selected” set in the selection flag field to “not selected” (step S1702).

The determining unit 605 sets the provisional yield sum Qv to “Qv=0” (step S1703). The determining unit 605 refers to the evaluation results table 900 and selects from among the fields F[1] to F[n], a field F[i] having a selection flag of “not selected” and the greatest evaluation score (step S1704).

The determining unit 605 sets the selection flag field of the field F[i] in the evaluation results table 900 to “provisionally selected” (step S1705). The determining unit 605 refers to the evaluation results table 900 and identifies the yield q[i] of the field F[i] (step S1706).

The determining unit 605 adds the identified yield q[i] to the provisional yield sum Qv (step S1707) and judges if the resulting provisional yield sum Qv is greater than or equal to the differential yield Qd (step S1708). If the provisional yield sum Qv is less than the differential yield Qd (step S1708: NO), the determining unit 605 returns step S1704.

On the other hand, if the provisional yield sum Qv is greater than or equal to the differential yield Qd (step S1708: YES), the display control unit 606 controls the display 208 and changes the display color of the fields for which the selection flag field in the evaluation results table 900 is set to “provisionally selected”, to the color C2 (step S1709), ending the series of operations according to the flowchart.

Thus, a field combination satisfying the differential yield Qd, which changes depending on the fields selected by the user to cultivate the designated crop, can be determined each time a select instruction or a cancel-selection instruction for a field Fi is received.

An example of a field selection screen displayed on the display 208 of the crop cultivation support apparatus 100 will be described.

FIGS. 18A, 18B, 19A and 19B are diagrams depicting a field selection screen. In FIG. 18A, a field selection screen 1800 is a screen for selecting fields for cultivating the designated crop, from among the dispersed fields F1 to F16 on the map M.

In the field selection screen 1800, the display color of the graphics objects representing the fields F2, F4, F5, F8, F10, and F12 is the color C1. The color C1 is the color in which fields having “not selected” set in the selection flag field in the evaluation results table 900 are displayed.

The display color of the graphics object representing the fields F1, F6, F9, and F14 to F16 is the color C2. The color C2 is the color in which fields having “provisionally selected” set in the selection flag field in the evaluation results table 900 are displayed. Thus, the user can recognized that from among the fields F1 to F16, the fields F1, F6, F9, and F14 to F16 are fields that have been selected as a field combination satisfying the targeted yield of the designated crop.

The display color of the graphics objects representing the fields F3, F7, F11, and F13 is the color C4. The color C4 is the color in which fields having “under use for another crop” or “cultivation planned” set in the availability judgment field in the evaluation results table 900 are displayed. Thus, the user can recognize that the fields F3, F7, F11, and F13 are not available fields.

In the field selection screen 1800, crop data 1810 is information indicating the category, sub-category, cultivation season, and period of the designated crop. The category, sub-category, cultivation season, and period of the designated crop are identified from the suitable-field determination master 700. Further, a targeted yield box B1 is a box displaying the targeted yield of the designated crop. The targeted yield of the designated crop is identified from the suitable-field determination master 700.

A yield total box B2 is a box displaying the total yield of the fields selected by the user, i.e., fields for which a select instruction has been received. However, here, when a field on the map M is clicked, the yield of the field is added to the yield total and displayed highlighted. Further, a cultivation candidate field list 1830 is a chart displaying selected-field data of fields for which a user selected instruction has been received.

In the field selection screen 1800, when the cursor C is moved and the field F1 is clicked consequent to a user input operation, field data 1820 of the F1 is displayed. The field data 1820 is information indicating the field ID, field name, area, evaluation, details, yield, and past cultivation of the field F1. The field ID, field name, details, yield, and past cultivation of the field F1 are identified from the evaluation results table 900.

The area and evaluation of the field F1 are, for example, stored in a storage device such as the RAM 203, the magnetic disk 205, and the optical disk 207. A graphics ID of a graphics object displayed on the map and a field ID may correlated and stored, enabling the field ID to be identified from the graphics ID.

The user considers the position of the field F1 on the map M and the field data 1820, and judges whether to cultivate the designated crop in the field F1. If the designated crop is to be cultivated in the field F1, the cursor C is moved and when a select button B3 is clicked, a select instruction for the field F1 is input.

When the select instruction for the field F1 is input, the display color of the graphics object representing the field F1 is changed to the color C3 (FIG. 18B). As a result, the user can recognize that the field F1 has been selected as a field for cultivating the designated crop.

Further, when the select instruction for the field F1 is input, selected-field data 1831 of the field F1 in the cultivation candidate field list 1830 is displayed. The selected-field data 1831 is information indicating the field ID and field name of the field F1, and the category, sub-category, yield and the cultivation period of the designated crop. Thus, even when another field different from the field F1 is clicked on the map M, various types of information of the field F1 can be confirmed.

With reference to FIG. 19, an example will be described for a case in which although compared to a field of the display color C2, the field F10 is not suitable as a field for cultivating the designated crop, the field F10, which is close to the office OF, is selected with consideration of transit cost.

In the field selection screen 1800 depicted in FIG. 19A, when the cursor C is moved and the field F10 is clicked consequent to a user input operation, the field data 1910 of the field F10 is displayed. From the field data 1910, the user can recognize that the terrain and soil texture of the field F10 do not satisfy the suitable-field conditions.

Further, from the field data 1910, the user can recognize that since the past cultivation field is “no”, the designated crop has not been cultivated in the field F10 in the past. Thus, since the user plans to harvest a “10 Kg” yield of the designated crop from the field F10, the user can take countermeasures such as sowing more seeds than usual (e.g., a seed volume sown for a “12 Kg” yield of the designated crop).

Further, when the select button B3 is clicked and a select instruction for the field F10 is input, the display color of the graphics object representing the field F10 is changed to the color C3 (FIG. 19B). As a result, the user can recognize that the field F10 has been selected as a field for cultivating the designated crop.

Further, when the select instruction for the field F10 is input, selected-field data 1832 of the field F10 in the cultivation candidate field list 1830 is displayed. Thus, even when another field difference from the field F10 is clicked on the map M, various types information of the field F10 can be confirmed.

Consequent to the select button B3 being clicked and the select instruction for the field F10 being input, the operations depicted in FIGS. 16 and 17 are executed, the selection flag of the F6 is changed from “provisionally selected” to “not selected”, and the display color of the graphics object representing the field F6 is changed to the color C1.

In the field selection screen 1800, when the cursor is moved and a cancel button B4 is clicked after the field F1 or the field F10 has been clicked on the map M, the selection of the field F1 or the field F10 can be released. In the field selection screen 1800, if multiple fields have been selected on the map M, the crop cultivation support apparatus 100 may collectively display the field data.

In the field selection screen 1800, selection results of the fields selected by the user for cultivation of the designated crop are output by the crop cultivation support apparatus 100 as a cultivation plan for the designated crop. The form of output, for example, may be display on the display 208, printing by the printer 213, and transmission to an external apparatus via the I/F 209. Further, the selection results may be stored to a storage area such as that of the RAM 203, the magnetic disk 205, and the optical disk 207.

Although description has been given where for each of the fields of the field combination satisfying the targeted yield Qt of the designated crop, the selection flag is set to “provisionally selected” and the user sequentially selects the fields actually used to cultivate the designated crop, configuration is not limited hereto. For example, for each of the fields of the field combination satisfying the targeted yield Qt of the designated crop, the determining unit 605 may set the selection flag to “selected”. In this case, the display color of all the graphics objects representing on the map M, the fields of the field combination satisfying the targeted yield Qt of the designated crop is the color C3.

As described, according to the crop cultivation support apparatus 100 of the embodiment, based on the yield q[i] of the field F[i] among the cultivation candidates (fields F[1] to F[n]), a field combination satisfying the targeted yield Qt can be determined from among the F[1] to F[n]. Further, the crop cultivation support apparatus 100 enables the display format of the fields of the determined combination to be changed to a predetermined display format that is different from the display format of other fields and enables the fields for which the display format has been changed to be displayed on the map M.

As a result, the user can intuitively determine from among the dispersed fields F1 to Fn on the map M, a combination of fields that satisfy the targeted yield Qt of the designated crop and are suitable for cultivation of the designated crop. Further, the user can intuitively determine the relative positions of the dispersed fields Fi on the map M and the relative positions of the fields Fi with respect to the office OF. As a result, a suitable cultivation plan for a crop can be drawn without any particular skill related to agriculture and improved crop quality as well as more accurate product delivery management can be realized.

The crop cultivation support apparatus 100 calculates an evaluation score indicative of the suitability of a field F[i] as a field suitable for cultivation of the designated crop and thereby enables a combination of fields satisfying the targeted yield Qt to be sequentially determined from among the fields F[1] to F[n].

The crop cultivation support apparatus 100 enables a field combination to be determined that satisfies the differential yield Qd representing the difference of the estimated yield total Q and the targeted yield Qt, when a select instruction is received for a field Fi that is among the fields F1 to Fn and selected for cultivating the designated crop. As a result, a field combination satisfying the differential yield Qd, which changes depending on the fields selected by the user to cultivate the designated crop, can be determined each time a select instruction is received for a field Fi.

The crop cultivation support apparatus 100 enables a field combination to be determined that satisfies the differential yield Qd representing the difference of the estimated yield total Q and the targeted yield Qt, when a cancel-selection instruction is received for a field for which a select instruction has been received. As a result, a field combination satisfying the differential yield Qd, which changes depending on the fields selected by the user to cultivated the designated crop, can be re-determined each time a cancel-selection instruction is received for a field Fi.

The crop cultivation support apparatus 100 judges whether each of the fields Fi satisfies suitable-field conditions of a field suitable for cultivation of the designated crop and thereby enables fields satisfying conditions of a field suitable for cultivation of the designated crop to be retrieved as cultivation candidates, the fields F[1] to F[n].

The crop cultivation support apparatus 100 judges for each of fields Fi, whether the period of the field Fi overlaps the cultivation period of the designated crop and thereby enables available fields in which no crop is currently under cultivation to be retrieved as cultivation candidates, the fields F[1] to F[n].

Therefore, as described, the crop cultivation support method and the crop cultivation support apparatus enable display that allows the user to distinguish combinations of fields having a high suitability evaluation and satisfying the targeted yield Qt, from among the dispersed fields F1 to Fn on the map M. As a result, the user can intuitively judge the relative positions of the fields Fi on the map M and select cultivation fields, and the efficiency of crop cultivation planning can be improved.

The crop cultivation support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

The crop cultivation support method and the crop cultivation support apparatus effect improved efficiency in crop cultivation planning.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A crop cultivation support method executed by a computer, the crop cultivation support method comprising:
retrieving from among a plurality of dispersed fields displayed on a map on a screen, a set of fields as cultivation candidates for a designated crop, based on properties of the fields;
determining from among the set of fields and based on estimated yields of the designated crop for each of the fields in the set of fields, a field combination that satisfies a targeted yield of the designated crop;
changing a display format of each of the fields in the field combination to a predetermined display format that differs from a display format of other fields excluded from the field combination, and displaying the fields in field combination in the predetermined display format on the map.

2. The crop cultivation support method according to claim 1, comprising
calculating before the determining of the field combination and based on properties of the field, an index indicative of suitability of a field as a field suitable for cultivation of the designated crop, wherein
the determining of the field combination includes determining the field combination based on the index.

3. The crop cultivation support method according to claim 1, comprising
receiving after the display format of each of the fields in the field combination has been changed to the predetermined display format, a select instruction for a field to cultivate the designated crop, wherein
the determining of the field combination includes determining the field combination upon receiving a select instruction, and from among the set of fields for which no select instruction has been received, determining the field combination to satisfy a yield representing a difference of the targeted yield and the estimated yield of fields for which a select instruction has been received.

4. The crop cultivation support method according to claim 3, comprising
receiving after the display format of each of the fields in the field combination has been changed to the predetermined display format, a cancel-selection instruction for a field for which a select instruction has been received, wherein
the determining of the field combination includes determining the field combination upon receiving a cancel-selection instruction, and from among the set of fields for which no select instruction has been received, determining the field combination to satisfy a yield representing a difference of the targeted yield and the estimated yield of the fields for which a select instruction has been received excluding the field for which the cancel-selection instruction has been received.

5. The crop cultivation support method according to claim 1, comprising
judging before the retrieving of the set of fields, whether a field satisfies a condition of a field suitable for cultivation of the designated crop, based on properties of the field, wherein
the retrieving of the set of fields includes retrieving the set of fields based on results obtained at the judging.

6. The crop cultivation support method according to claim 1, comprising
judging before the retrieving of the set of fields, whether a field is an available field, based on a period for cultivation of the designated crop and a period of crop cultivation in the field, wherein
the retrieving includes retrieving the set of fields based on results obtained at the judging.

7. A crop cultivation support apparatus comprising
a display that displays a plurality of fields on a map; and
a processor programmed to:
retrieve from among the fields, a set of fields as cultivation candidates for a designated crop, based on properties of the fields,
determine from among the set of fields and based on estimated yields of the designated crop for each of the fields in the set of fields, a field combination that satisfies a targeted yield of the designated crop,
control the display, change a display format of each of the fields in the field combination to a predetermined display format that differs from a display format of other fields excluded from the field combination, and display the fields in the field combination in the predetermined display format on the map.
